(19) United States
(12) Patent Application Publication
(10) Pub. No.: US 2006/0198719 A1
(43) Pub. Date: Sep. 7, 2006

(54) Apparatus and method of applying a hardcover assembly to a bound stack

(76) Inventors: Kevin P. Parker, Berkeley, CA (US); Ted T. Christianson, Alamo, CA (US); Stephanie G. Morgan, Oakland, CA (US)

Correspondence Address: Philip A. Girard;GIRARD & EQUITZ LLP, Suite 1110, 400 Montgomery Street, San Francisco, CA, 94104, US

(21) Appl. No.: 11/074,001

(22) Filed: Mar. 7, 2005

(51) Int. Cl. B42C 11/00

(52) U.S. Cl. 412/4

(57) ABSTRACT

An end leaf assembly for use in attaching a hardcover assembly to a stack of sheets to form a hardcover book and related method. The assembly includes first and second leaf sections, preferably formed from a folded single sheet, with the first leaf section being substantially the same size of the sheets of the stack. A strip of pressure sensitive adhesive, disposed on the second end leaf along the fold of the single sheet, is provided for securing a portion of the second end leaf an outer sheet of the stack. The pressure sensitive strip is disposed on the second end leaf at least 1/16 of an inch from the fold and is preferably no wider than 2.0 inches in the direction normal to the fold. The first leaf section is provided for securing the end leaf assembly to an interior surface of one of the covers of the hardcover assembly. A second end leaf assembly having similar construction can be used for securing to the opposite outer sheet of the stack and to the interior surface of the other cover of the hardcover assembly.

### BACKGROUND OF THE INVENTION

1. Field of the Invention

The present invention relates generally to the field of bookbinding and, in particular, a method and apparatus of applying a hardcover assembly to a bound stack to form a hardcover book.

2. Description of Related Art

Binding systems for binding stacks of sheets into a book using desktop equipment have increased in popularity. One popular system uses a binder strip having and adhesive surface, such as disclosed in U.S. Pat. No. 4,496,617. The binder strip is typically applied to a stack of sheets to be bound using a desktop binding machine such as disclosed in U.S. Pat. No. 5,052,873. The binding machine carries out the binding operation by suitably positioning the binder strip relative to the stack to be bound and applying heat and pressure so that the edges of the stack are bound. The bound stack does not, however, have the same general appearance as books using commercial binding processes, particularly that of hardcover books.

Various approaches have been used to produce hardcover books using desktop equipment that closely resembles mass produced hardcover books. One successful prior art approach will now be described. Referring to the drawings, FIG. 1 shows a stack of sheets 15 to be bound into a hardcover book. A first folded liner sheet 12, forming sheets 12A and 12B the same size as the sheets to be bound, is positioned on the top of the stack 15 and a second folded liner sheet 14, forming sheets 14A and 14B, is positioned on the bottom of the stack. The liner sheets 12 and 14 are preferably of a relatively heavy stock as compared to the sheets 15 to be bound. Once the liner sheets 12, 14 and stack of sheets 15 have been assembled, the combined stack 10 is bound together using a conventional binder strip 16 as described in the above-noted U.S. Pat. No. 4,496,617, the contents of which are hereby fully incorporated by reference into the present application. The actual binding is preferably is carried out using a desktop binding machine as described in the above-noted U.S. Pat. No. 5,052,873, the contents of which are hereby fully incorporated by reference into the present application. The bound stack 10 is shown in FIG. 2, with the adhesive present in the binder strip 16 operating to bind the individual sheets together and to the heavy paper substrate of the binder strip 16.

FIG. 3 shows details of a prior art hardcover assembly 18 that is to be applied to the bound stack 10 of FIG. 2. Typically, the cover assembly 18 is completely assembled and sold separately to the user. As will be described, the cover assembly 18 can be manufactured in various sizes to accommodate differing size stacks 10 in terms of stack thickness. It is further anticipated that a user can request that certain information be preprinted on the assembly 18, including title information and any other graphics. As will be described, hardcover assembly 18 includes relatively rigid front and back cover sections 18A and 18B, respectively, separated by a relatively flexible spine section 18C.

The cover assembly 18 includes a pair of relatively stiff cover boards 24A and 24B made of cardboard or the like. The cover boards 24A and 24B are typically 8⅜ inches by 11 5/16 inches for binding 8½ by 11 inch stack 10. The cover boards are covered with a flexible cover membrane 22, typically fabric, which is folded around the edges of the cover boards, as depicted in FIG. 3. That part of the cover membrane 22 disposed intermediate the opposite edges 25A and 25B of the cover boards is unsupported and is thus relatively flexible. A length of fabric or stiff paper, typically 0.010 inches thick, is preferably disposed in the spine section 18C of the hardcover assembly 18 so as to slightly stiffen the membrane 22 in that location so that a desired shape is achieved when the bound book is opened and closed. The membrane regions 28A and 28B disposed between the respective edges of the spine section 26 and the respective edges 25A and 25B of the cover boards 24A and 24B are referred to as gutter regions. The gutter regions 28A and 28B are each fixed in width at ⅜ of an inch. The gutter regions define the flexible portion of the cover membrane. Alternatively, a spine board (not depicted), made of the same material as the cover boards 24A and 24B and having a shape that generally corresponds to the spine region 26, can be used. The spine board, which is typically 0.088 inches thick, functions to stiffen the spine 26, with spine flexibility being provided by the flexible gutter regions 28A and 28B disposed between the respective edges of the cover boards 24A and 24B and the respective edges of the spine board. When the spine board is used, the gutter region 28A and 28B widths are preferably increased slightly to 7/16 of an inch.

The spine region 26 width varies, along with the width of the spine board if one is used, depending upon the width of the stack 10 to be bound. The cover assemblies are preferably prefabricated in various widths to accommodate stacks 10 of various widths as set forth below in Table 1.

TABLE 1

| | Spine 26 | Stack |
|---|---|---|
| | Width | Thickness |
| Model | (inches) | (inches) |
| A | ⅜ | To ¼ |
| B | ½ | ¼ to ½ |
| C | ¾ | ½ to ¾ |
| D | 1 | ¾ to 1 |
| E | 1¼ | 1 to 1 ¼ |
| F | 1½ | 1¼ to 1½ |

The number of available spine widths can be increased or decreased from the values set forth above in Table 1, with a larger number increasing the difficulty of maintaining an adequate inventory and a smaller number detracting somewhat from the appearance of the final product in the spine region.

Referring back to FIG. 3, the cover assembly 18 is prefabricated using a pair of pressure sensitive adhesive sheets structure 30A and 30B. Further details of the adhesive sheets are also shown in FIGS. 4 and 5. Adhesive sheet structures 30A and 30B are dimensioned 8¼ by 10¾ inches when the stack 10 size is 8½ by 11 inches, to cover the interior periphery of the folded portions of the cover membrane 22A and 22B and to further secure the periphery of the membrane to the respective cover boards 24A and 24B. The smaller size of the underlying sheets 32A and 32B of the sheet structure ensures that the folded liner sheets 12A and 14A completely cover sheets 32A and 32B despite any small misalignment. Each sheet structure 30A/30B includes respective bottom sheets 32A and 32B and respective upper major release liner 36A and 36B. A respective layer of pressure sensitive adhesive 34A and 34B is disposed intermediate that upper liner and bottom sheet. A pressure sensitive adhesive manufactured by National Starch and Chemical Company and marketed under the designation Instant-Lok, type HL PSA 20-81, has been found suitable for this application. The adhesive layers 34A and 34B are preferably 0.003 to 0.004 inches in thickness.

The upper major release liners 36A and 36B are disposed over a majority of the underlying pressure sensitive adhesive layers. Generally, at least 75% of the adhesive layers are covered by the respective upper major release liners 36A and 36B, with a remaining strip of the adhesive along the inner edge of the sheet structures not being covered by the major release liners 36A and 36B. Instead, upper minor release liners 38A and 38B are disposed over the exposed adhesive strips. This relationship is shown schematically in FIG. 5 (not to scale) for adhesive sheet structure 30B where only a portion of the sheet structure is depicted. As can be seen, the pressure sensitive adhesive layer 34B is disposed between the bottom sheet 32B and upper major and minor release liners 36B and 38B. That portion of the adhesive layer 34B not covered by the upper major release liner 36 is covered by a separate upper minor release liner 38B. The minor release liner 38B is actually positioned contacting the adhesive layer 34B and is secured in place by the adhesive layer. As is well known, all of the release liners 36A, 38A, 36B and 38B are fabricated from a material that only slightly adheres to the pressure sensitive adhesive so that the release liners can be manually separated from the adhesive without damage to the adhesive or the release liners. As part of the prefabrication of the hardcover assembly, conventional case glue 56 (not depicted in FIGS. 4 and 5) is applied to the top of the cover sections 18A and 18B and to the bottom sheets 32A and 32B. The sheet structures are then positioned over the respective cover sections 18A and 18B as shown in FIG. 3 so that the sheet structures will be secured to the cover sections by the case glue. Thus, the sheet structures 30A and 30B are secured to the cover boards 24A and 24B and to the peripheral portions of the cover membrane 22 by way of the case glue. This completes the prefabrication of the prior art hardcover assembly 18.

Referring now to FIGS. 6 and 7, a prior art guide apparatus 40 is disclosed for use in carrying out the binding process. The guide apparatus includes a flat base member having a receiving surface 42 that is somewhat larger that the largest book to be bound when the book is in the open position. A stop member 44 having two orthogonal segments is supported on the upper surface 42 of the base member and extends around two adjacent sides of the base member. A ledge member 46, also having two orthogonal segments, is supported above the stop member 44 and, as can be in FIG. 7, have outer edges 46A which extend past the edge 44A of the stop member a small distance X, with the overhang being typically 0.14 inches. The height of the ledge member above the support surface is great enough to accommodate the thickness of the cover sections 18A and 18B of the cover assembly 18. The ledge member 46 extends along stop member 44 in one direction a distance Y (FIG. 6) which is somewhat smaller than the closed width of the smallest book to be bound. The distance Z, the distance that the ledge member 46 extends along stop member 44 in the other direction, is typically about twice dimension Y.

The guide apparatus 40 also preferably includes two or more vertical stop members, such as 48A, 48B and 48C, with vertical stop member 48A being supported on ledge member 46 about one third of the distance Y of the ledge member from the corner formed by the intersection of the two ledge member 46 segments. Vertical stop member 48B and 48C are at approximate equal distances along the other ledge member 46 segment. As can best be seen in FIG. 7, the vertical stop members each have a planar surface, surface 50C for example, that coincides with the inner edge, edge 44A for example, of the stop member. This configuration also applies to the planar surfaces 50A and 50B of vertical stop members 48A and 48B.

The prior art book binding sequence will now be described, starting with reference to FIG. 8A. The opened hardcover assembly 18 is first positioned on the guide apparatus receiving surface 42, with the upper release liners 36A and 36B facing upwards. As indicated by arrow 52, the hardcover assembly is moved along the surface 42 of the guide apparatus until the edges of cover section 18B is positioned under the ledge member 46, abutting the inner edge 44A of the stop member 44, as shown in FIG. 7. Thus, the outer edge 46A of the ledge member 46 will be positioned a fixed distance X from the edge of cover 18B along the full length of both orthogonal segments of the ledge member 46. The outer edge 46A will provide a guide for positioning the bound stack 10, as will be described.

Once the hardcover assembly 18 is properly positioned on the guide apparatus 40, the user manually separates the upper minor release liner 38B as shown in FIG. 8B from the assembly 18. This will expose a relatively narrow strip of the underlying pressure sensitive adhesive 34B adjacent spine region 26. Next, the bound stack 10 is placed over the upper major release liner 36B, with the edges of the stack engaging edge 46A of the ledge member 46 along both orthogonal segments. FIG. 7 shows the edge of stack 10 engaging edge 46A along one of the two segments. As shown in FIG. 8C by arrows 52, that portion of stack 10 along the exposed adhesive 34B is not placed on the exposed adhesive until the orthogonal edges of the stack are positioned against edge 46A of both segments. Once the correct position is achieved, the stack is forced down upon the exposed pressure sensitive adhesive 34B as shown in FIG. 8D. This operates to secure the folded liner sheet 14A of stack 10 to cover section 18B of the hardcover assembly 18 in a correctly aligned position.

The next step is to secure the remainder of the folded liner sheet 14A of stack 10 to the adhesive 34B of assembly 18. Referring to FIG. 8E, the free edge of stack 10, including liner sheet 14A, is lifted up and rotated away from the upper major release liner 36B. This permits the release liner 36B to be separated from the hardcover assembly 18 thereby exposing the remainder of the pressure sensitive adhesive 34B. As shown in FIG. 8F, the spine portion of stack 10 held down against the hardcover assembly 18 with one hand while stack 10 is rotated over the adhesive 34B with the other hand. As shown in FIG. 8G, the user then presses the stack 10 down on the hardcover assembly 18. This causes the remainder of the liner sheet 14A of the stack to be secured by the remainder of adhesive 34B to cover section 18B of the hardcover assembly 18. The second cover section 18A of the hardcover assembly will now be attached.

Referring to FIG. 8H, the upper minor release liner 38A is next separated from the hardcover assembly 18 thereby exposing a strip of pressure sensitive adhesive 34A adjacent spine region 26. The user then lifts the cover section 18A of the hardcover assembly away from the surface 42 of the guide apparatus and rotates the cover 18A around the spine. As indicated by arrows 54 of FIG. 8I, the cover section 18A is positioned so that the edges of the cover section 18A contact the planar surfaces 50A, 50B and 50C of the respective three vertical stop members 48A, 48B and 48C. This is shown in phantom in FIG. 7. The hardcover assembly 18 is then positioned correctly with respect to the bound stack 10. The user then forces the cover section 18A down as shown in FIG. 83 so that an edge of folded liner sheet 12A of stack 10 is secured to the hardcover assembly 18 by way of the exposed strip of adhesive 34A.

As shown in FIG. 8K, the user then lifts cover section 18A up and rotates the cover away from stack 10, with a narrow strip of liner sheet 12A of the stack remaining secured to cover section 18A. This permits upper major release liner 36A to be separated from hardcover assembly 18 thereby exposing the remainder of pressure sensitive adhesive layer 34A. Cover 18A is then rotated back down onto stack 10, where the edges of the cover should again be in contact with the surfaces 50A, 50B and 50C of the respective stops 48A, 48 and 48C as shown in FIG. 8L by arrows 58. The user then presses down on cover section 18A as shown in FIG. 8M thereby securing the cover section 18A to folded liner sheet 12A of stack 10. This completes the binding sequence.

FIGS. 9A and 9B show the completed book in a closed position and FIG. 10 shows the book in an opened position, at the last page of the book, so that folded liner sheets 14A and 14B are depicted. Sheet 14A is secured to hardcover section 18B by way of adhesive 34B and sheet 12A at the front of the book (not depicted) is secured to hardcover section 18A by adhesive 34A. The region between the binder strip 16 and the spine region 18C is not attached so that, when the book is opened as shown in FIG. 10, the spine region does not attempt to fold with the binder strip 16. Thus, the book will lay flat when opened and will not tend to fold shut. Further, the spine region 18C will not distort when the book is opened to the same degree it would if the spine region 18C was attached. As previously noted, a fairly stiff fabric strip 29 is positioned in the spine region intermediate the gutter regions 28A and 28B (FIG. 3) so as to hold the shape of the spine region 29 when the book is opened and closed. Fold lines 27A and 27B are formed naturally in the membrane 22 in the regions near the edges 25A and 25B of the cover boards thereby further enhancing the appearance of the final product.

There may be occasions where there is a requirement to apply a hardcover assembly to a stack of sheets that have been previously bound using more conventional prior art methods such as stitching or the like, rather than adhesive binder strips 16 as shown in FIG. 2. By way of example, FIGS. 11A and 11B show a stack of sheets 60 bound together using stitching 62. Stack 60, which includes a first page 60A and a last page 60B, could receive a hardcover assembly 18 as previously described provide a functionally adequate bound book. Unfortunately, the stitching 62 would remain visible when the book is opened thereby greatly detracting from the appearance of the completed book. There is a need for a method and related apparatus which permits a hardcover assembly to be applied to stacks of sheets that have been bound using stitching and the like, such as stack 60, in a manner such that the stitching or other binding medium is not visible in the final product. As will become apparent to those skilled in the art from a reading of the following Detailed Description of the Invention together with the drawings, the present invention successfully addresses this issue, in addition to providing further advantages.

### SUMMARY OF THE INVENTION

An end leaf assembly for use in attaching a hardcover assembly to a stack of sheets to form a hardcover book and related method are disclosed. The assembly includes first and second leaf sections, preferably formed from a folded single sheet, with the first leaf section being substantially the same size of the sheets of the stack. A strip of pressure sensitive adhesive, disposed on the second end leaf along the fold of the single sheet, is provided for securing a portion of the second end leaf an outer sheet of the stack. The pressure sensitive strip is preferably disposed on the second end leaf at least 1/16 of an inch from the fold and is preferably no wider than 2.0 inches in the direction normal to the fold. The first leaf section is provided for securing the end leaf assembly to an interior surface of one of the covers of the hardcover assembly. A second end leaf assembly having similar construction can be used for securing to the opposite outer sheet of the stack and to the interior surface of the other cover of the hardcover assembly.

In one embodiment, a reinforcing member is folded around the fold of the end leaf assembly, with a first section of the reinforcing member being disposed intermediate the second leaf section and the strip of pressure sensitive adhesive and with a second section of the reinforcing member being disposed, after application to the hardcover assembly, intermediate the first leaf section and the interior surface of a cover of the hardcover assembly. In one embodiment, the reinforcing member is made from a string woven fabric.

### BRIEF DESCRIPTION OF THE DRAWINGS

FIG. 1 is a perspective view of a stack of sheets to be bound, including the front and back folded liner sheets as per the prior art.

FIG. 2 is a perspective view of the stack of sheets of FIG. 1 after binding using a conventional binder strip as per the prior art.

FIG. 3 is a perspective exploded view of a prior art hardcover assembly, with the pressure sensitive front and rear sheets structures shown displaced from the remainder of the assembly.

FIG. 4 is a perspective view of one of the two prior art pressure sensitive adhesive sheet structures.

FIG. 5 is a cross-section elevational view of a portion of the adhesive sheet structure of FIG. 4.

FIG. 6 is a perspective view of a prior art the guide apparatus used to attach the hardcover assembly to the bound stack.

FIG. 7 is an expanded side view of a portion of the guide apparatus of FIG. 6 with a stack to be bound shown in position.

FIGS. 8A-8M depict a prior art process for assembling the hardcover book.

FIGS. 9A and 9B are perspective views of portions of the completed prior art hardcover book.

FIG. 10 is a perspective broken view of the completed prior art book shown in an open position.

FIGS. 11A and 11B are perspective views of a prior art stack of sheets bound using stitching techniques.

FIG. 12A is a perspective view of one embodiment of an end leaf assembly and FIG. 12B is and end view of the same assembly.

FIG. 13 is a perspective-expanded view of the bound stack and two FIG. 12A/B end leaf assemblies.

FIG. 14 is an expanded view of the FIG. 13 assembly being inserted into a conventional desktop binding machine.

FIG. 15 is a partial end view of the FIG. 13 assembly after being secured by an adhesive binder strip using the conventional desktop binding machine.

FIG. 16 is a partial schematic end view of the FIG. 15 assembly after a hardcover assembly has been added.

FIG. 17 show the sequence for removing the release section of one of the two end leaf assemblies and for a securing leaf section of the assembly by way of the exposed pressure sensitive adhesive.

FIG. 18A is a perspective view of a further embodiment end leaf assembly and FIG. 18B is an end view of the same assembly.

FIG. 19A is a perspective view of a still further embodiment end leaf assembly and FIG. 19B is an end view of the same assembly.

FIG. 20 is an expanded perspective view of a bound stack, with the front page including a photograph together with a pair of further embodiment end leaf assemblies, with one assembly having viewing windows.

FIG. 21 is a perspective view of a bound hardcover book bound using the end leaf assemblies of FIG. 20 and covered by a prior art hardcover assembly having a viewing window.

FIGS. 22A-22Q show the sequence of applying a prior art hardcover assembly to a bound stack without the use of an adhesive binder strip.

FIG. 23 shows a prior art hardcover assembly with a pair of end leaf assemblies installed, with the end leaf assemblies to be used to secure to a bound stack to the hardcover assembly without the use on an adhesive binder strip.

FIG. 24 is a schematic top view of a bound hardcover book using the end leaf assemblies of FIG. 20 and without the use of an adhesive binder strip.

FIG. 25 is a schematic top view of a bound hardcover book using the end leaf assemblies of FIG. 20 and with an adhesive binder strip.

FIGS. 26A and 26B are perspective views of a further embodiment end leaf assembly having a reinforcing member for use in applying a hardcover assembly to a stack without the use of an adhesive binder strip.

FIG. 27 is a partial schematic view of a bound hardcover book using the reinforced end leaf assembly of FIGS. 26A and 26B.

FIGS. 28A-28D depict a further embodiment end leaf assembly.

FIGS. 29A-29B depict an end leaf assembly similar to, and for use with, the assembly of FIGS. 28A-28D.

FIGS. 30A-30K show the manner in which the FIGS. 28A-28D embodiment end leaf assemblies can be applied to a bound stack and then secured to a hardcover assembly.

FIGS. 31A-31E show the manner in which the FIGS. 28A-28D embodiment end leaf assemblies can be applied to a hardcover assembly so that the bound stack can be secured to the hardcover assembly.

### DETAILED DESCRIPTION OF THE INVENTION

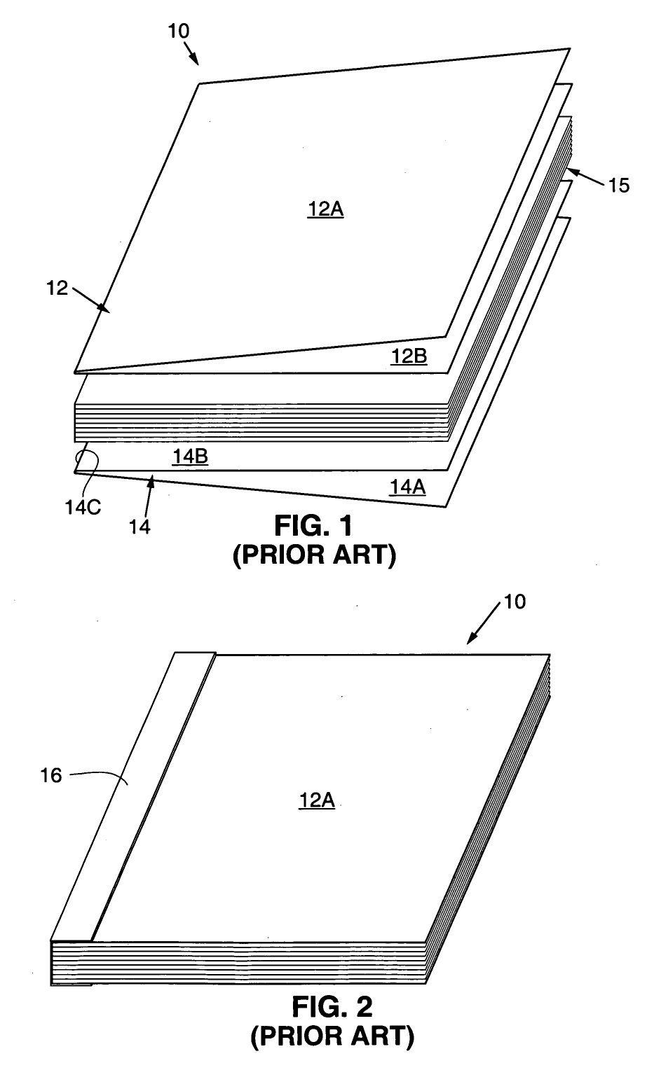

Referring again to the drawings, FIGS. 12A and 12B show a first end leaf assembly 64 in accordance with one embodiment of the present invention which, when combined with a second end leaf assembly, can be used to secure a stack to a hardcover assembly 18 to form a hardcover book. Generally, a pair of the end leaf structures 64 functions to replace end leaf structures 12 and 14 of FIG. 1, as will be described.

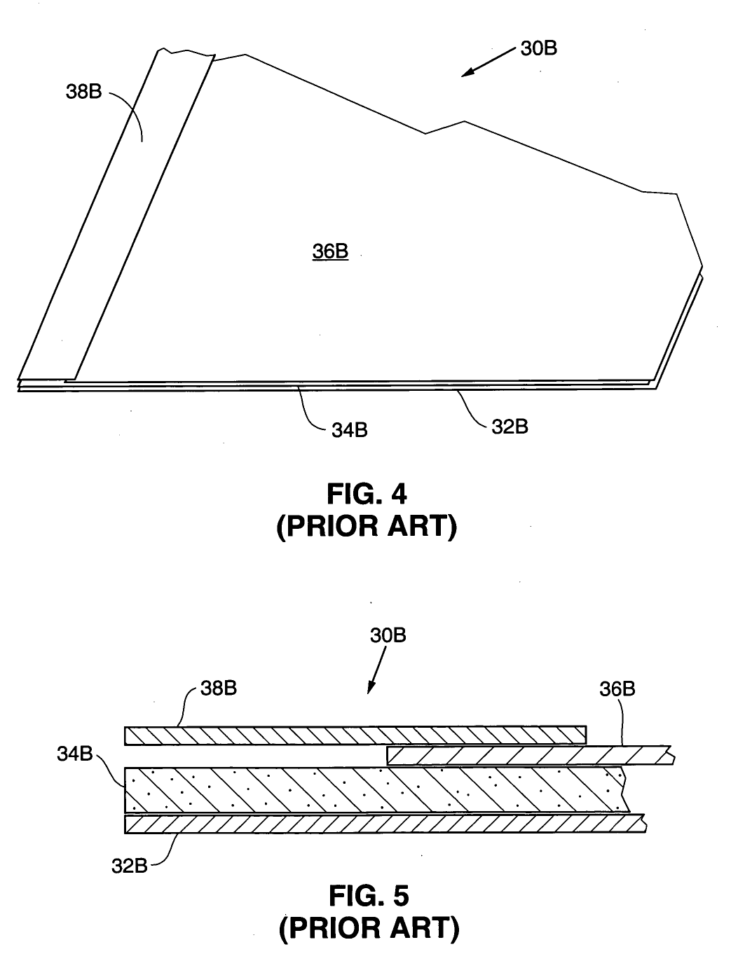

End lead assembly 64 includes a leaf section 68A that preferably is the same size as a sheet of the stack 60 to be formed into a hardcover book. A second leaf section 68B is provided which, in the present exemplary embodiment, is the same size as section 68A. Leaf sections 68A and 68B are preferably formed from a single folded sheet of relatively heavy stock paper, with the fold line (edge) being designated by the numeral 68C. A strip 70 of pressure sensitive adhesive is disposed on leaf section 68B, extending along substantially the full length of the fold line 68C. The pressure sensitive adhesive strip 70 is preferably displaced from the fold line 68C a small distance so that the strip is not contacted by heat activated adhesive sometimes used in the binding process, as will be described. The lower edge of strip 70 is at least 1/16 of an inch from fold line 68C and preferably about ⅛ of an inch. Further, adhesive strip 70 is wide enough in the direction normal to the spine so as to extend over the stitching 62 or the like of stack 60 to be covered, as will also be described. In this regard, the strip 70 should be no wider than 2.0 inches and preferably about 5/32 of an inch. Adhesive strip 70 is covered by release section 72, with release section or liner 72 preferably being made of the same materials as the various release liners previously described, for example, in connection with FIG. 4. Such material, which usually include silicon, provides sufficient adhesion to hold the release section 72 is place over the pressure sensitive adhesive 70 while permitting the release section to be manually removed without damage to either the adhesive or the release section itself. In the event the release liner or section 72 includes a silicon coating on both sides, the section can extend all the way down to the fold line 68C since the binder strip 16 adhesive will not adhere to the liner section. The width of release section 72 is wide enough to cover the adhesive strip 70 and the height is great enough to enable a user to easily grip the section during removal. In the present example, the height is slightly greater than the height of the sheets of the stack 60 and leaf sections 68A and 68B.

FIG. 13 shows the relative arrangement of two of the end leaf assemblies 64 and 66 relative to a bound stack 60 to be covered. End leaf assembly 64 is positioned with the release section 72 positioned adjacent cover sheet 60A of the stack 60, with assembly 66 being positioned with the release section 78 adjacent cover sheet 60B of the stack. With the end leaf assemblies 64 and 66 and stack 60 arranged as shown in FIG. 13, the combination is secured together, preferably using the same desktop binding machine used to produce the bound stack 10 of FIG. 2 and as disclosed in U.S. Pat. No. 5,052,873. FIG. 14 shows such a binding machine 80 receiving the FIG. 13 combination together with a conventional binder strip 16. As is well known, the binding machine will function to apply the binder strip 16 to the combination, thereby securing two cover assemblies 64 and 66 and previously bound stack 60 together as shown schematically in FIG. 15. The heat activated adhesive (not depicted) of the binder strip 16 functions to secure the end or spine of stack 60 to the strip substrate (designated as 16) along with a portion 75 of leaf section 74A and a portion 77 of leaf section 68A to the substrate. Note that the end of the release sections 78 and 72, together with adhesive strips 70 and 76 are disposed a sufficient distance from respective fold lines 68C and 74C, preferably at least 1/16 of an inch to ensure that the pressure sensitive adhesive is not contaminated by the molten heat activated adhesive of the binder strip 16 and to ensure that the molten adhesive does not contact the edges of release sections 72 and 78 thereby interfering in the subsequent removal of the release sections.

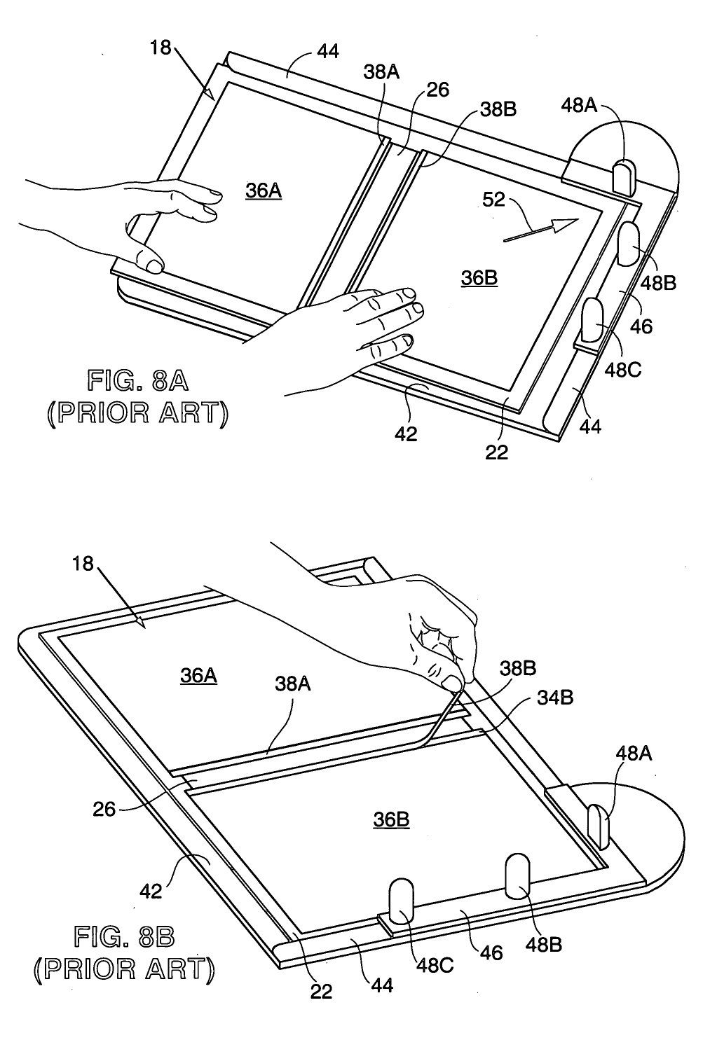

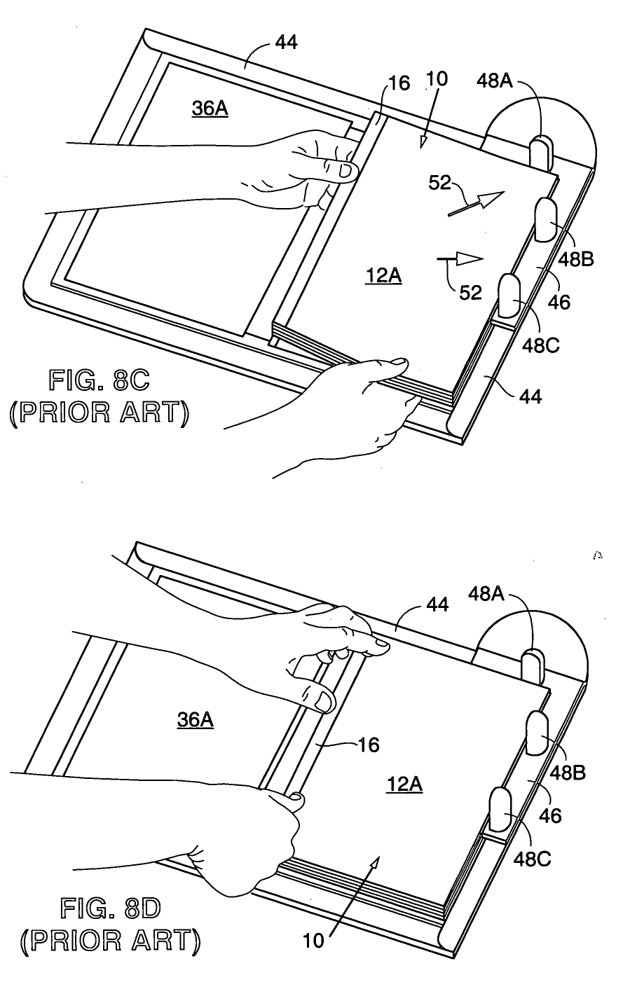

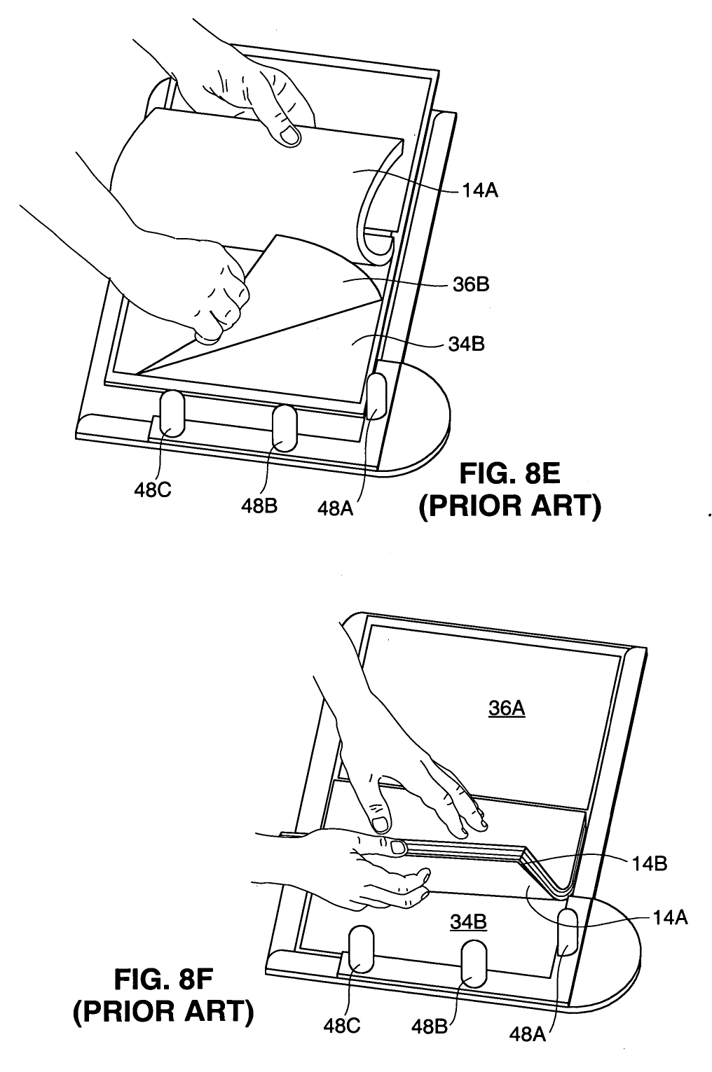

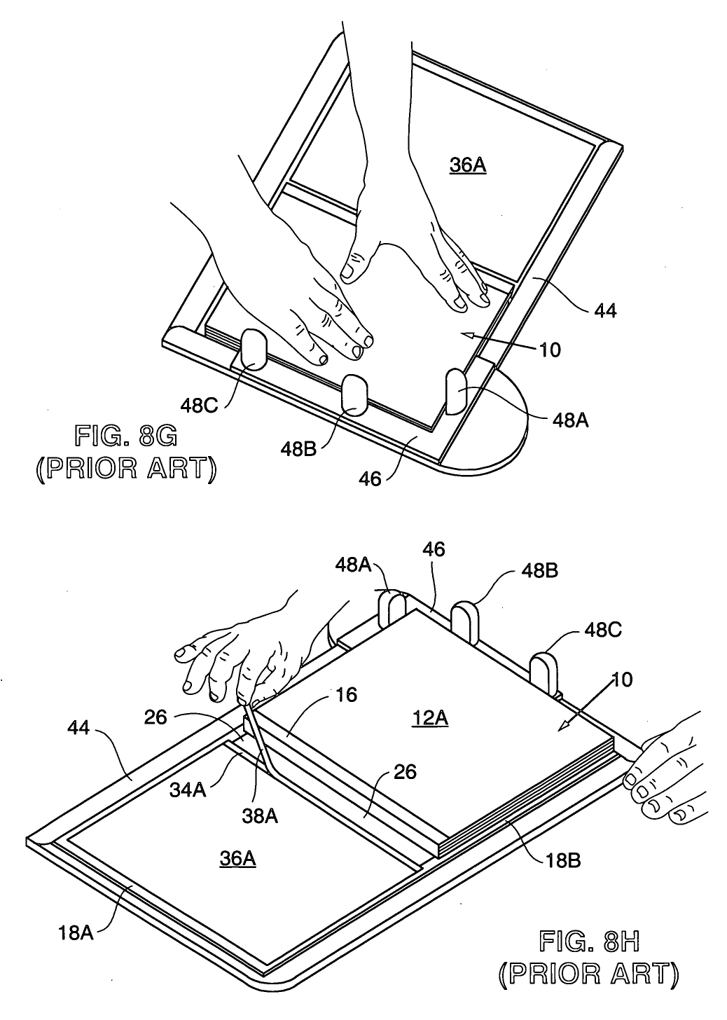

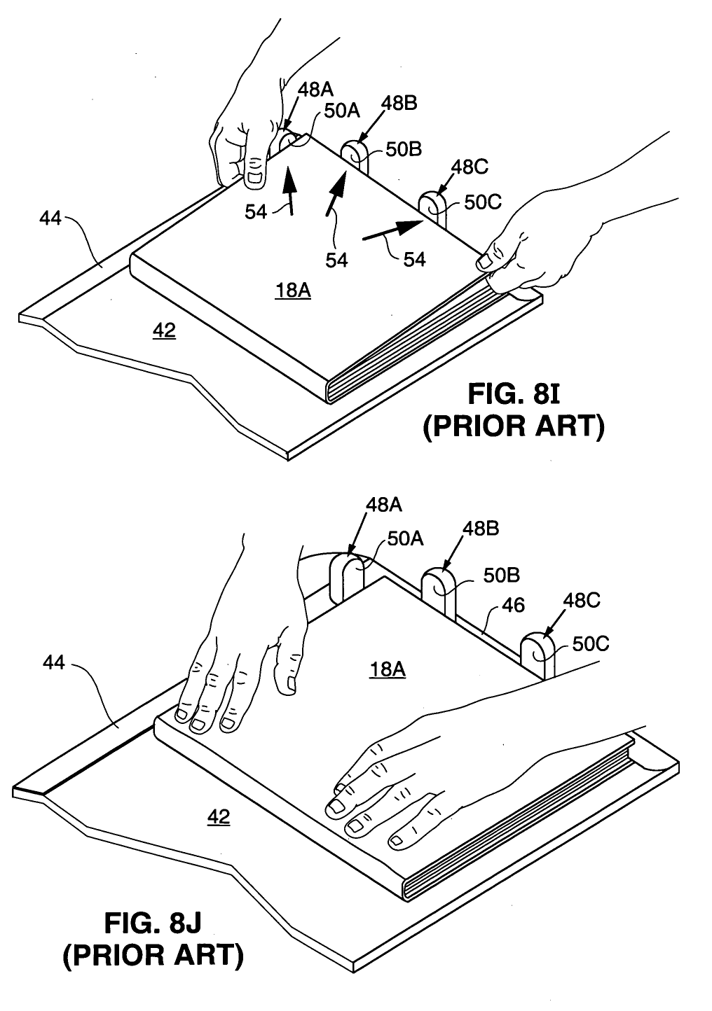

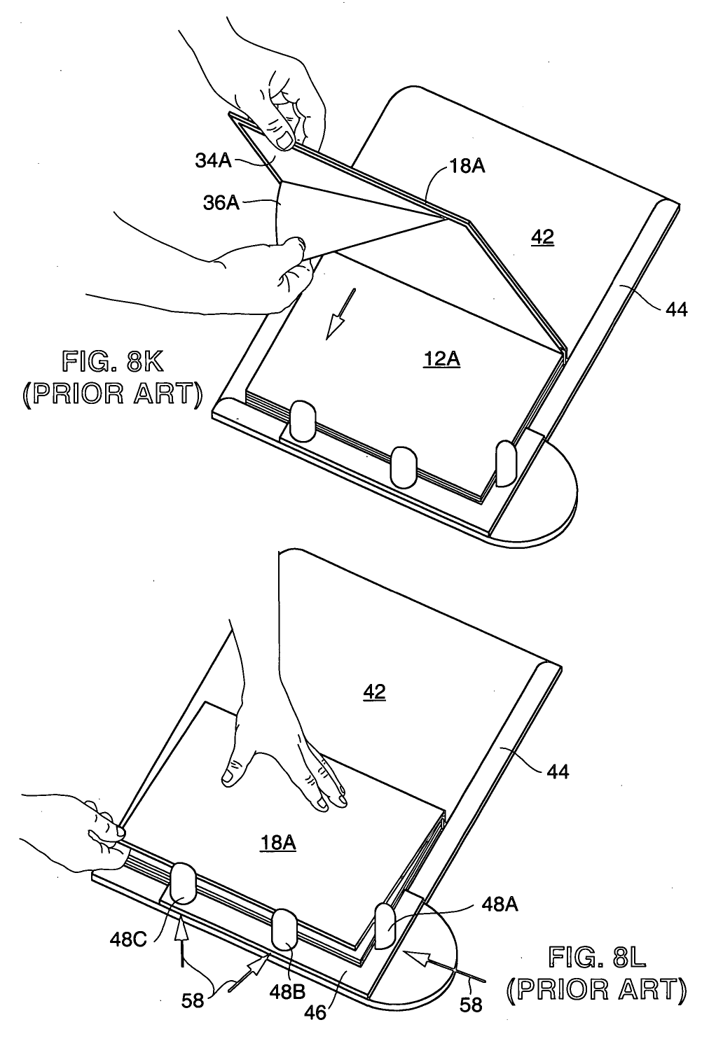

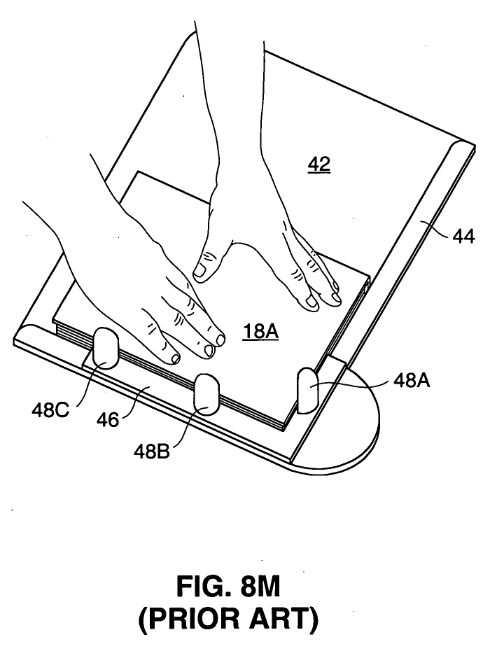

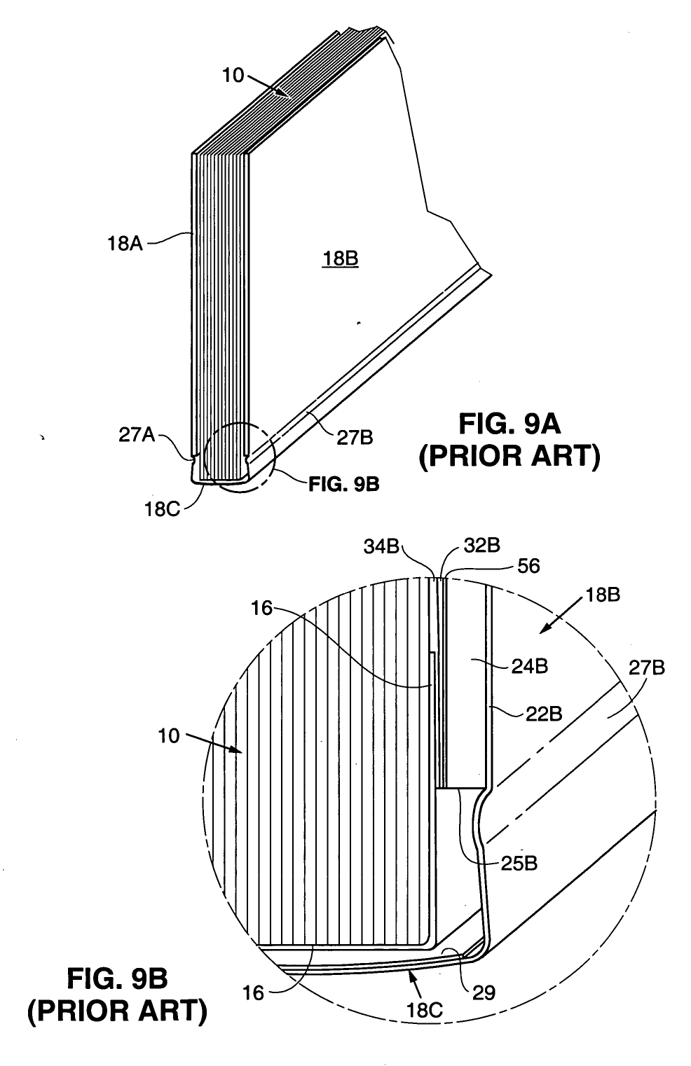

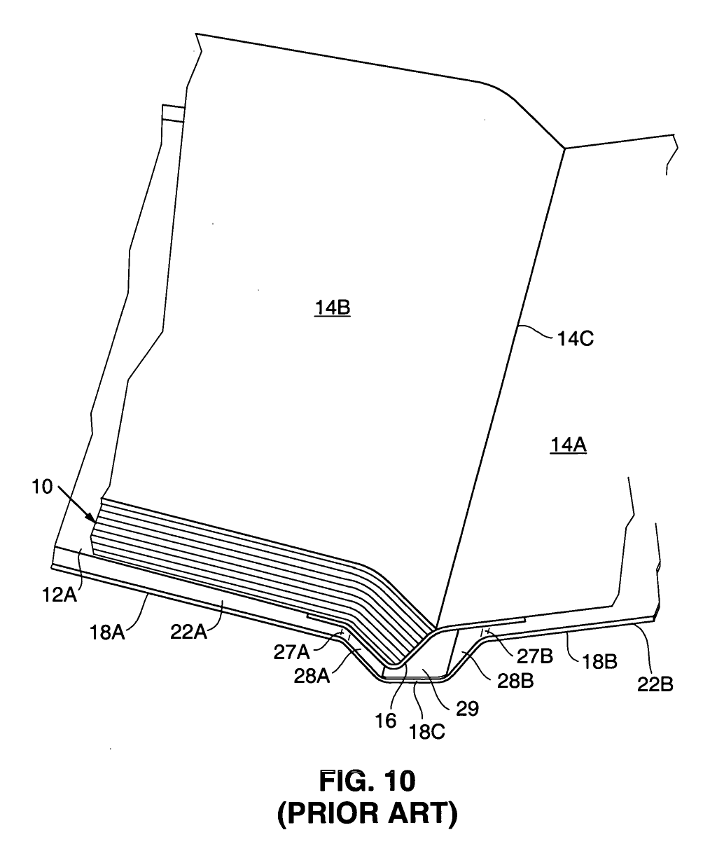

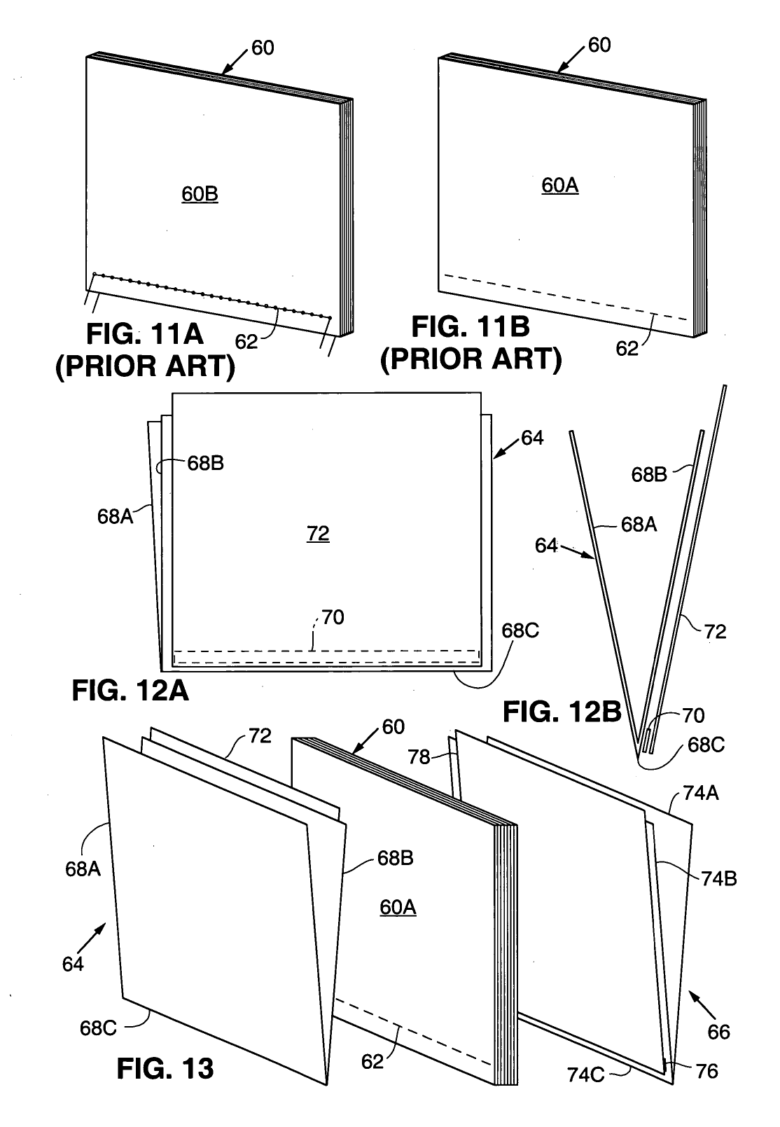

The next step is to apply a hardcover assembly 18 to the FIG. 15 combination. This is carried out substantially as previously described in connection with FIGS. 8A-8M. The resultant structure is partially depicted in schematic form in FIG. 16. As a result of the steps shown in FIGS. 8A-8G, the release liners 38B and 36B of back cover section 18B of the hardcover assembly 18 are removed thereby exposing the underlying pressure sensitive adhesive 34B which secures leaf section 68A and part of the binder strip substrate 16 (FIG. 16) to back cover section 18B of the hardcover assembly. Steps 8H-8M show the removal of release liners 38A and 36A so as to expose the underlying pressure sensitive adhesive 34A which secures leaf section 68A (FIG. 16) and part of the binder strip substrate 16 to front cover section 18A of the hardcover assembly.

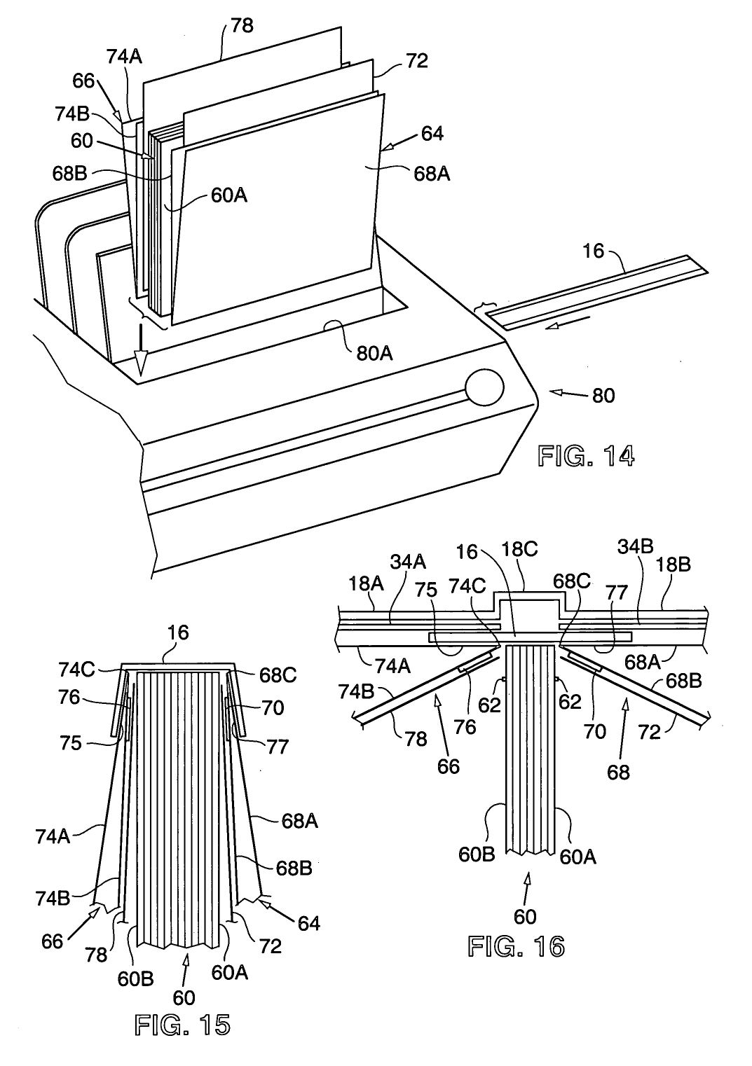

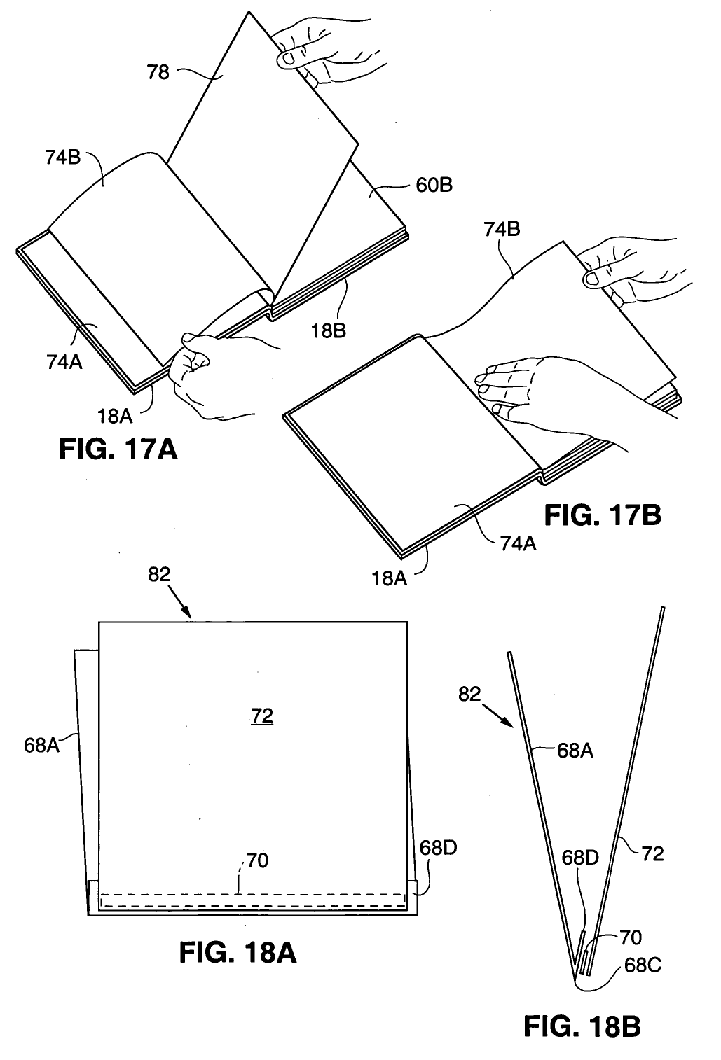

As can be seen in FIG. 16, at this point in the assembly, stitching 62 of the bound stack 60 remains visible. As shown in FIG. 17A, the user manually removes release section 78 thereby exposing the underlying pressure sensitive adhesive strip 76. As shown in FIG. 17B, the user then presses leaf section 74B against the bound stack 60 thereby securing a relatively small portion of leaf section 74B to the outer sheet 60B of the stack thereby covering or masking stitching 62 on one side of the stack. Release section 72 is removed in a similar manner so that exposed pressure sensitive adhesive 70 can function to secure a small portion of leaf section 68B to the outer sheet 60A of the stack thereby masking the stitching on that side of the stack. As previously noted, adhesive strips 70 and 76 are preferably no wider than 2.0 inches so that a maximum of 2.0 inches of leaf sections 74B/68B is secured to the front and back pages of the stack 60. This completes the sequence of applying the hardcover assembly 18 to the assembly. The result is an attractive hardbound book with none of the stitching visible.

Although it would be possible to remove the release sections 72 and 78 prior to adding the hardcover assembly 18, it is preferred that the sections be removed as described.

FIGS. 18A and 18B show an alternative embodiment end leaf assembly 82 which provides essentially the same function as assembly 64 of FIGS. 12A and 12B and used in combination with a hardcover assembly 18 and stack 60 in essentially the same manner. Assembly 82 includes an end leaf section 68A and a release section 72 which are sized similarly to the corresponding elements of assembly 64. The second end leaf section 68D of assembly 82 is substantially smaller than end leaf section 68B of assembly 64, but is still sufficiently sized to cover stitching 62 of a stack 60. Thus, when a hardcover book bound made using end leaf assembly 82 is opened, the first page 60A of the bound stack 60 is the first page rather than leaf section 68B of the first embodiment end leaf assembly 64. It would be possible to use end leaf assembly 82 at the front page 60A of the stack where there may printed information of interest is the first page and to use end leaf assembly 64 at the back page 60B of the stack where leaf section 74B functions as the last page.

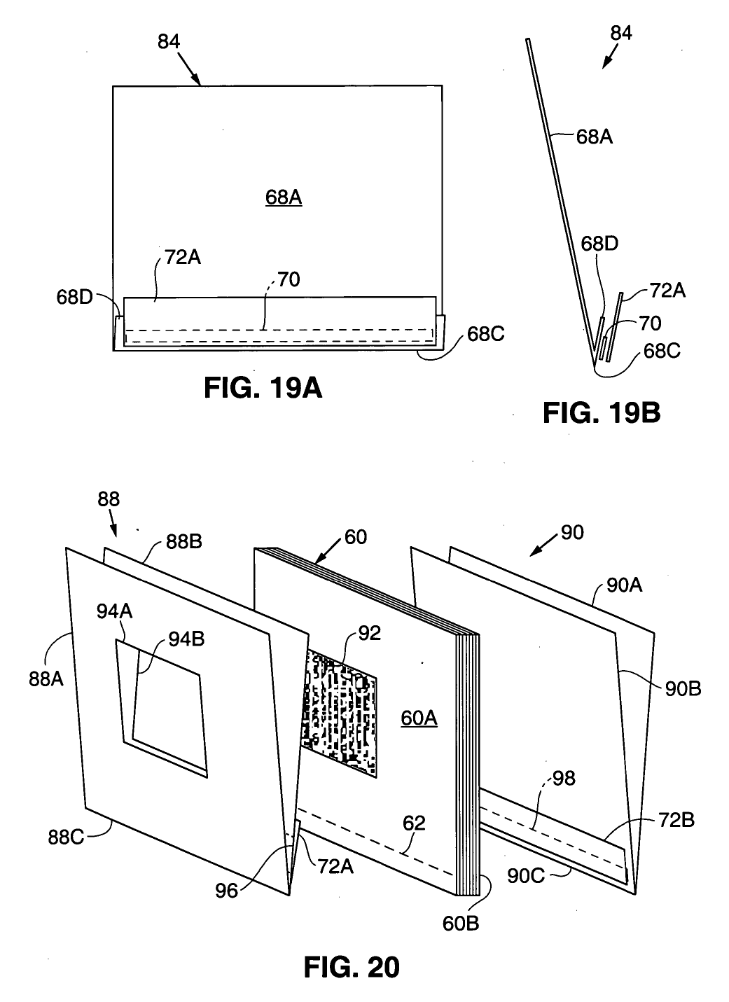

A still further embodiment end leaf assembly 84 is shown in FIGS. 19A and 19B. Again, end leaf assembly 84 is applied to the stack 60 and hardcover assembly 18 in the same manner as assemblies 64 and 82. Assembly 84 is substantially the same as assembly 82 (FIGS. 18A and 18B) except that the release section 72A of assembly 84 is much smaller that release section 72 of assembly 82. In the event assembly 84 is used, the user must open the bound book slightly wider to provide access to the release sections.

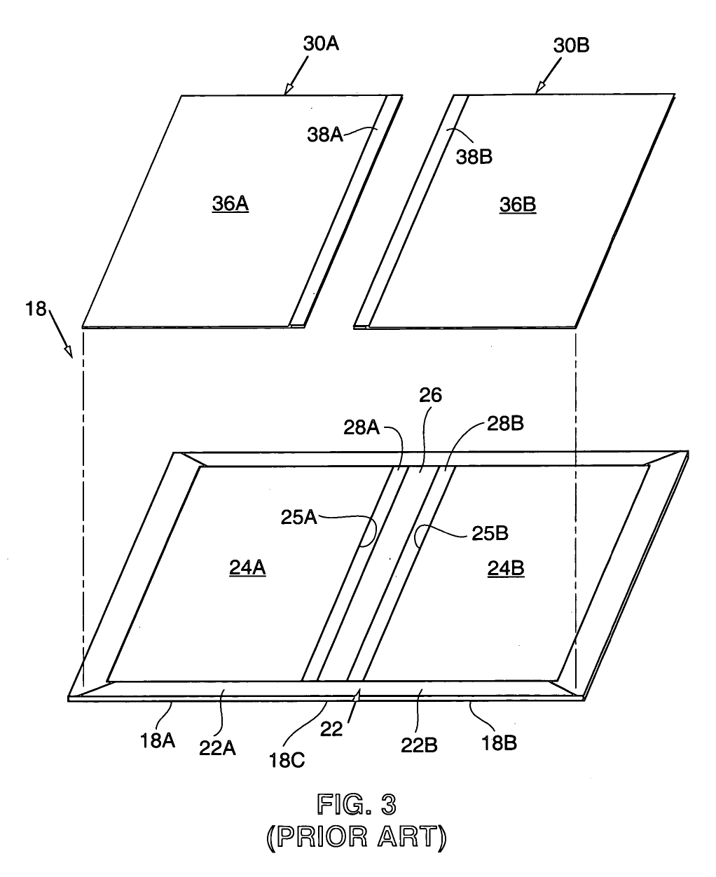

Some prior art hardcover books are provided with a front hardcover having an opening or window through which a photograph or other printed information on the first page can be seen without opening the book. Such prior art books use a hardcover assembly 18 as shown in FIG. 3 except there is an appropriately sized window formed in front cover section 18A of the hardcover assembly 18. A further embodiment end leaf assembly 88 as shown in FIG. 20 can be used to create this type of book when the book has been bound using stitching 62. The end leaf section 88A has an opening or window 94A that corresponds in size to the window 100 formed in front cover section 18A of the hardcover assembly 18. Typically, window 100 corresponds to that portion of the image 92 of stack 60 to be viewed when the book is closed. A similar sized opening 94B is provided in end leaf section 88B. Note that end leaf assembly 88 includes a pressure sensitive adhesive strip 96 covered by a short release section 72A similar to strip 70 and release section 72A of assembly 84. A second end leaf assembly 90 is used at the back of stack 60, with assembly 90 being similar to assembly 88, but without the openings 94A and 94B.

The stack 60 and two end leaf assemblies 88 and 90 are arranged relative to one another as shown in FIG. 20 and are then secured together as previously described in connection with FIG. 14. Next, the secured combination is encased in a hardcover assembly 18 having a viewing window as also previously described. Finally, release sections 72A and 72B are removed and the respective leaf sections 88B and 90B are pressed against the stack 60 so that the leaf sections are each adhered to the lower part of the stack thereby masking the stitching. The final product is shown in FIG. 21.

There may be circumstances where it is desired by encase previously bound stack 60 (FIGS. 12A and 12B) where a binding machine such as machine 80 (FIG. 14) is not available. In that event, the subject end leaf assemblies can be used to add a hardcover assembly 18 to a previously bound stack 60, with this being a somewhat less preferred approach. The first step in the sequence is to secure the subject end leaf assemblies to a prior art hardcover assembly 18 and to then secure the bound stack 60 to the hardcover assembly 18 using the end leaf assemblies.

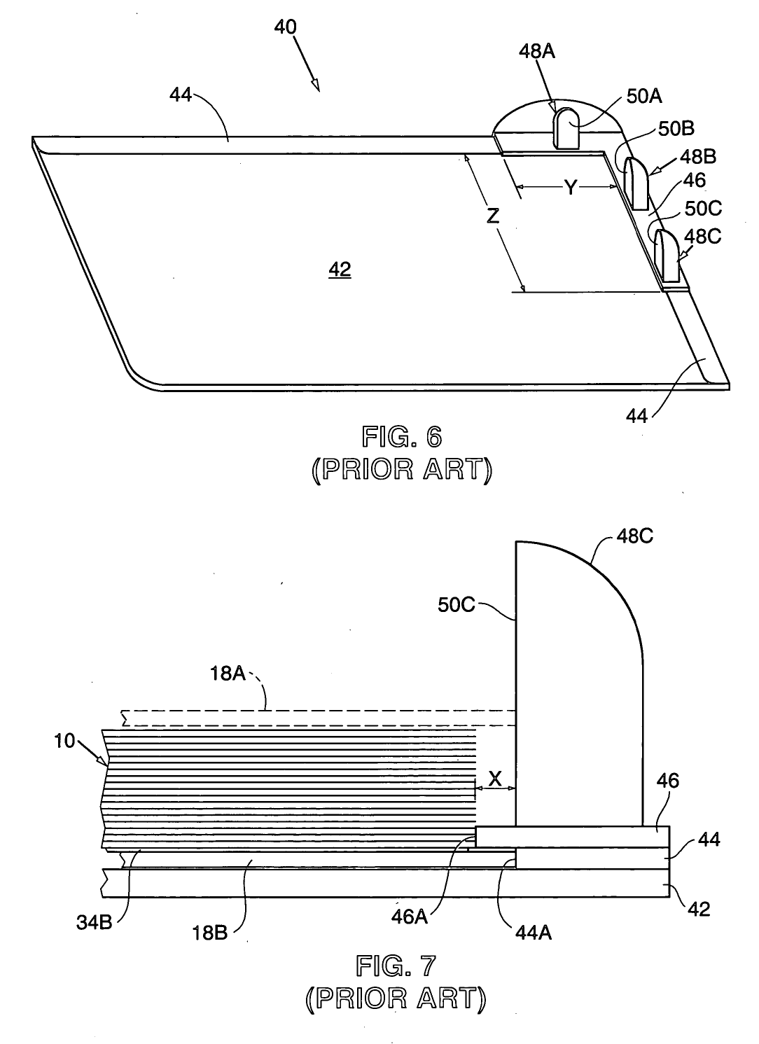

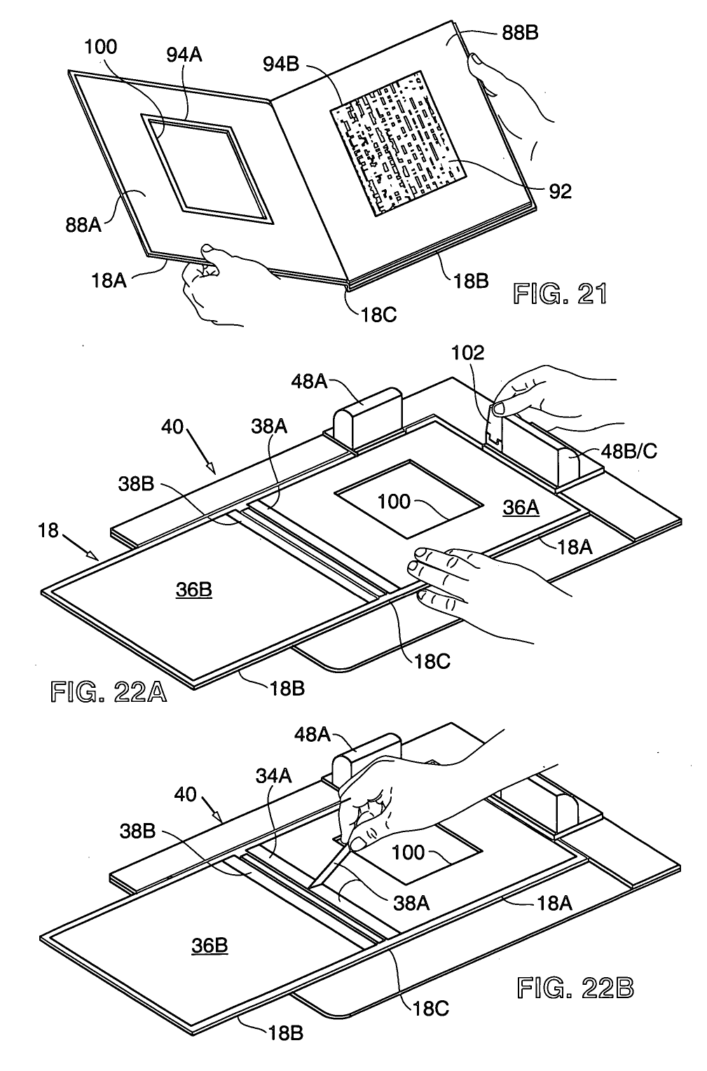

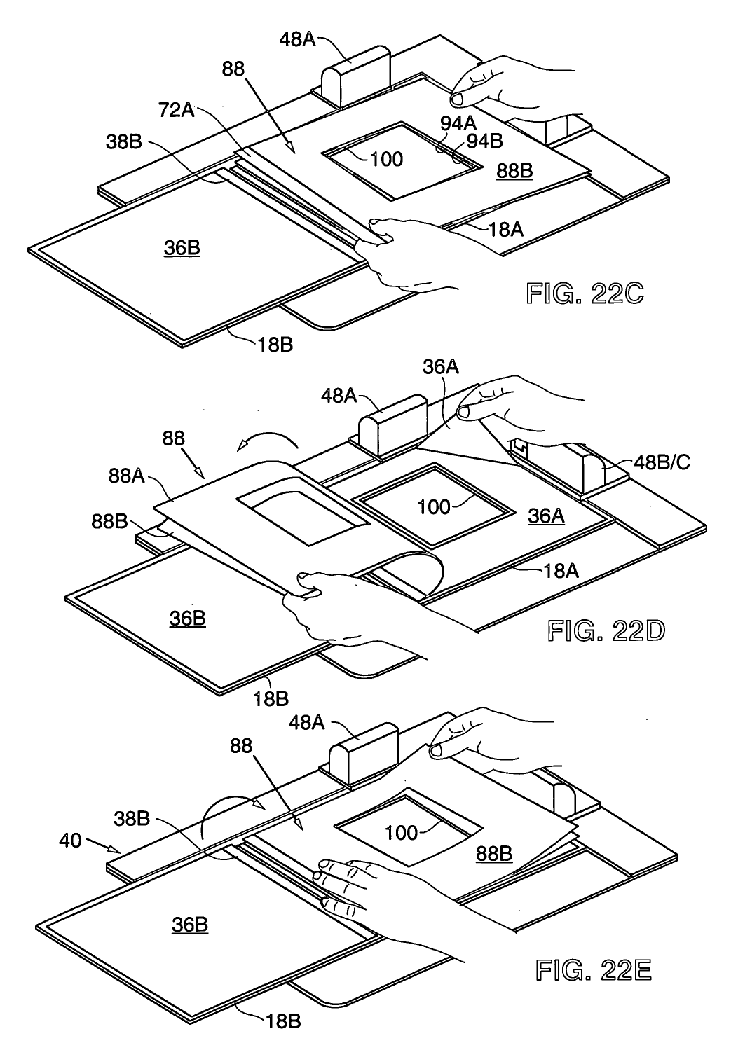

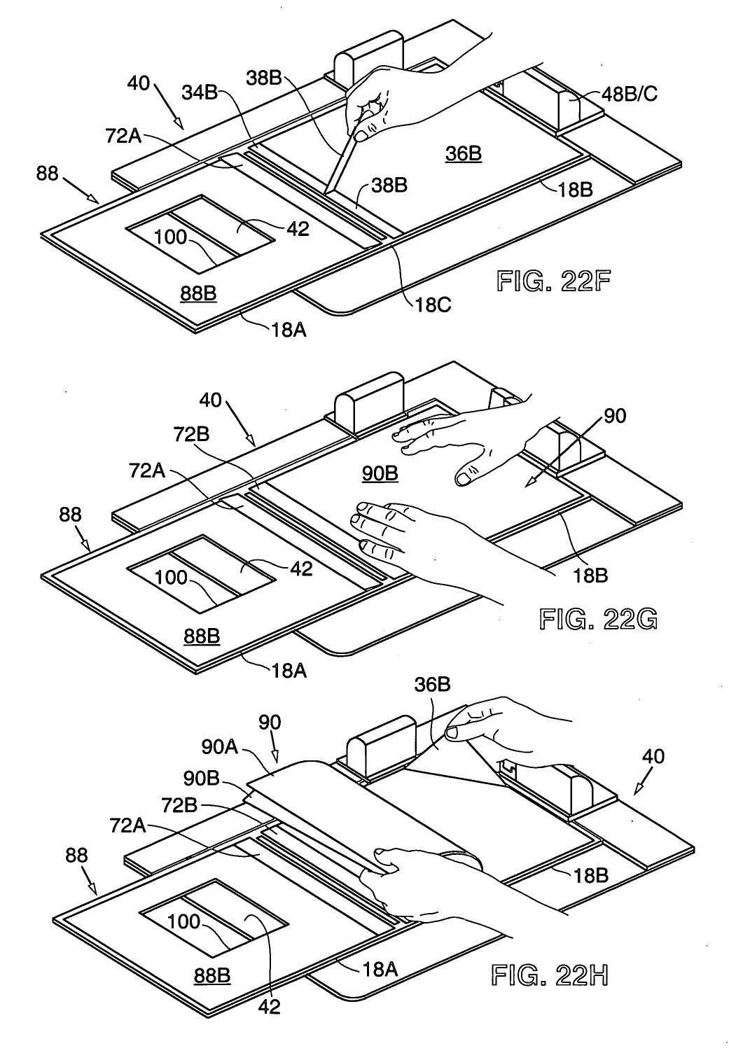

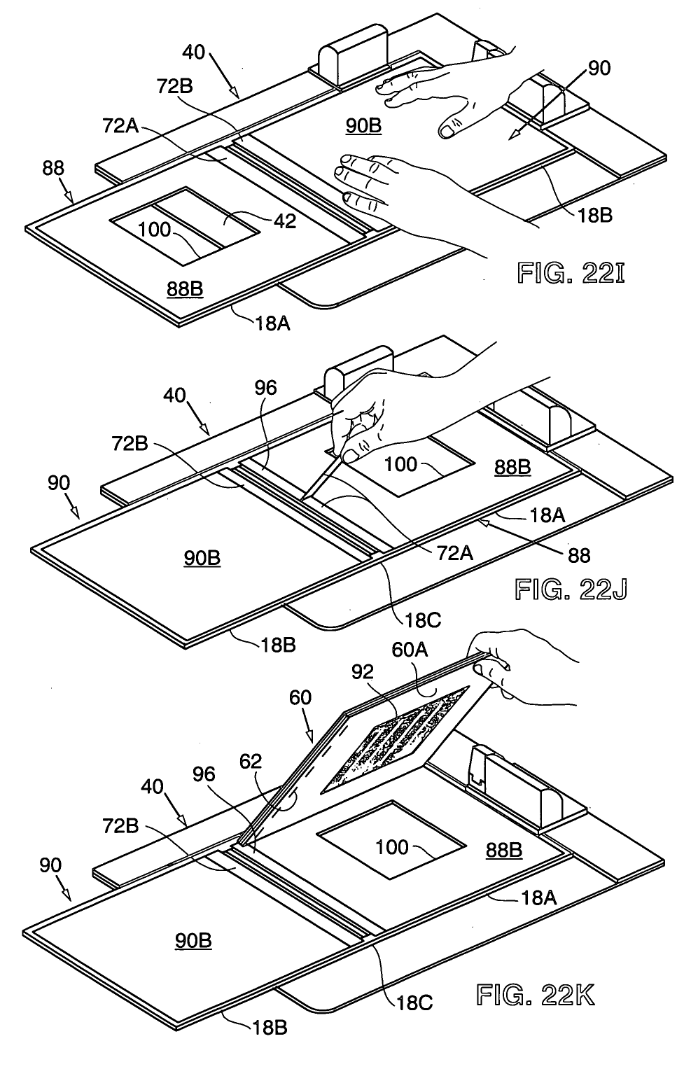

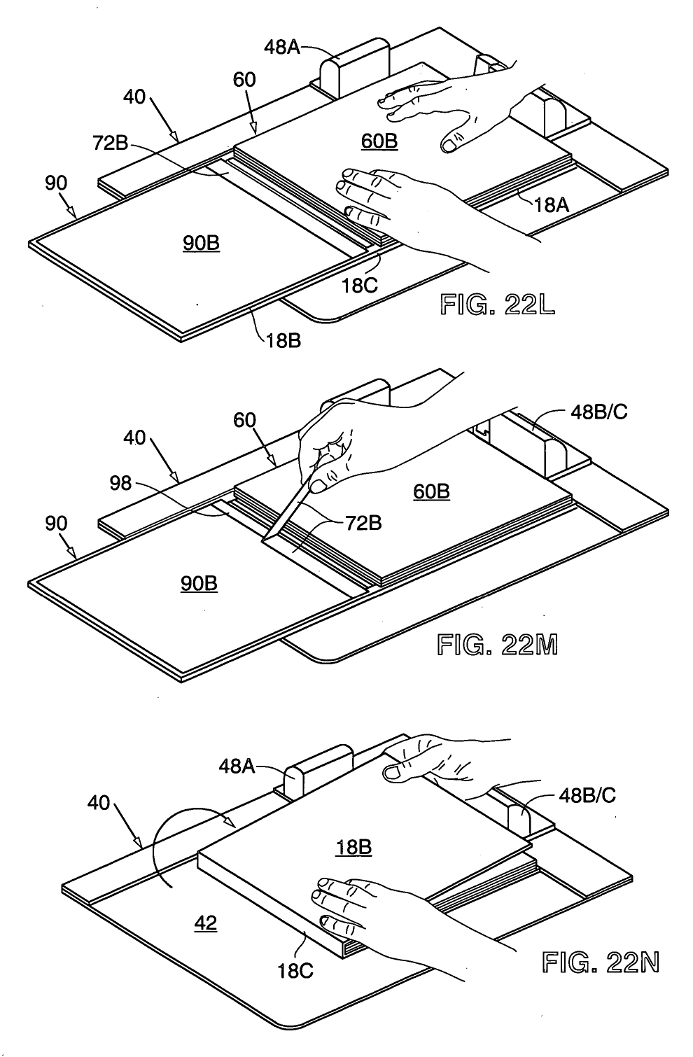

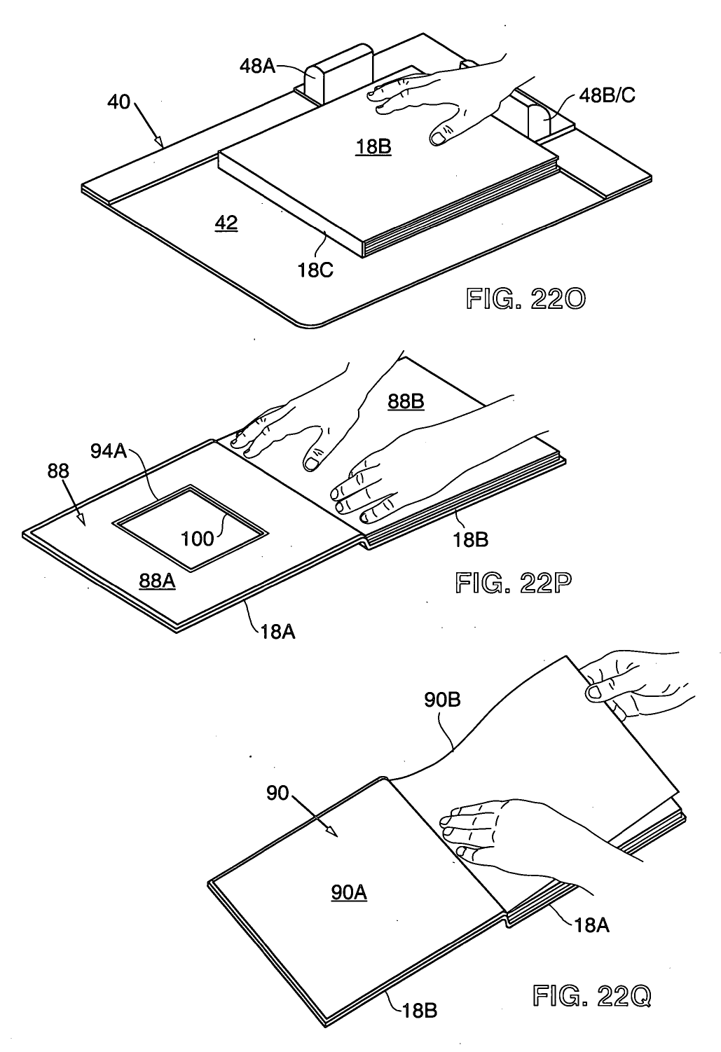

In the present example, a hardcover assembly 18 having a viewing window 100 such as previously described in connection with FIG. 20 will be used. Preferably, a hardcover guide, such as the prior art guide 40 previously described in connection with FIGS. 6-8M, is used to accurately position the end leaf assemblies on the hardcover assembly 18. Guide 40 shown in FIG. 22A is similar to the previously described guide in most respects, and includes a stop 48A that provides the same function as corresponding stop 48A of FIG. 6 and a wide stop 48B/C that provides the same function as corresponding stops 48B and 48C of FIG. 6. As shown in FIG. 22A, the hardcover assembly 18 is initially positioned on the receiving surface 42 of guide 40, with the two orthogonal edges of front cover section 18A positioned abutting the edge 44A (FIG. 7) near stop 48A and stop 48B/C. A clamping mechanism 102 is provided in the FIG. 22A guide 40 which clamps down on one outer edge of front section 18A thereby helping to hold the cover section 18A secure on the guide 40.

With the hardcover assembly 18 in place as shown in FIG. 22B, the user removes minor release liner 38A (see also FIG. 3) thereby exposing a small section of the underlying pressure sensitive adhesive 34A. As shown in FIG. 22C, the end leaf assembly 88 is then positioned over front cover section 18A of the hardcover assembly, with the edges of the end leaf assembly that are facing stops abutting the outer edges 46A (FIG. 7) of the ledge member 44. This initial positioning, which is done without the end leaf assembly contacting the exposed adhesive 34A, ensures that the end leaf assembly is accurately positioned over the front cover section 18A of the hardcover assembly 18. Next, the user presses the end leaf assembly 88 down on the exposed strip of pressure sensitive adhesive 34A so that a small portion of the underlying leaf section 88A is adhered to the front cover section 18A. This action locks the end leaf assembly into the desired position.

As shown in FIG. 22D, the user then lifts the free end of the end leaf assembly 88 thereby revealing the underlying major release liner 36A of the hardcover assembly 18. The edge of the assembly 88 remains secured by the narrow strip of adhesive 34A during this step. The release liner 36A is removed so as to expose the remainder of the pressure sensitive 34A. The user then presses the end leaf assembly 88 down upon the exposed adhesive 34A, as shown in FIG. 22C thereby completely securing leaf section 88A of the end leaf assembly to the front cover section 18A of the hardcover assembly. At this point, the windows 94A and 94B (FIG. 20) of the assembly should be closely aligned with the window 100 of the hardcover assembly.

The sequence is repeated for securing the end leaf assembly 90 to the back cover section 18B of the hardcover assembly. The hardcover assembly 18 is first repositioned on the guide apparatus 40, with back cover section 18B abutting edges 44A (FIG. 7) of the guide. The rear cover section 18A is then secured in place by way of clamp 102 (FIG. 22A) so that the cover section is secured on the guide apparatus. Next, minor release liner 38B (see FIG. 3 also) is removed as shown in FIG. 22F thereby exposing a narrow strip of underlying pressure sensitive adhesive 34B. The user then positions end leaf assembly 90 over the back cover section 18B with the edges of the end leaf assembly abutting the outer edges 46A (FIG. 7) of the guide apparatus so that the end leaf assembly is accurately positioned with respect to the back cover section 18B. As before, this initial positioning is done without the end leaf assembly 88 contacting the exposed strip of adhesive 34B. As can be seen in FIG. 22G, the user then presses the end leaf assembly 90 down so that the leaf section 90A of the end leaf assembly 88 will be secured in proper alignment by the adhesive 34B.

As shown in FIG. 22H, the user then lifts the free end of the end leaf assembly 90 away from the back cover section 18B to as to permit the underlying major release liner 36B (see FIG. 3 also). The release liner 36B is then removed so as to expose the remainder of the pressure sensitive adhesive 34B and, as shown in FIG. 22I, the end leaf assembly 90 is then pressed against the back cover section 18B thereby accurately securing the end leaf assembly 90 in place. At this point, the completed assembly is ready to receive the bound stack 60. It should also be noted that such completed assembly, at this point, could be manufactured and sold to an end user rather than having the end user apply the two end leaf assemblies to the hardcover assembly. Such completed assembly 104 is shown in FIG. 23.

The user next repositions the hardcover assembly with front and back cover sections 18A and 18B on the guide apparatus 40 in essentially the same manner as previously described in connection with FIG. 8A. If a clamp mechanism is available, the mechanism is used to assist in holding the assembly in place. As shown in FIG. 223, the user then manually removes release section 72A of the end leaf assembly 88 thereby exposing pressure sensitive adhesive 96. The user then positions the bound stack 60 over the end leaf assembly 88 using the outer edges 46A (FIG. 7) as a guide. Initially, such positioning is performed without the stack 60 contacting the adhesive 96. After the initial positioning, the stack 60 is carefully lowered down on the leaf section 88B so that the edge of the stack near the spine will contact the exposed adhesive 96 and the stack is then pressed down against the leaf section 88B as shown in FIG. 22L. This secures the stack 60 to front cover section 18A of the hardcover assembly.

As can be seen in FIG. 22M, the user then removes release section 72B of end leaf assembly 90 so as to expose adhesive strip 98 of end leaf assembly 90. The user then lifts up back cover section 18B and rotates the cover section over the bound stack 60, while avoiding contacting the exposed adhesive 98 until the edges of the cover section 18B abut stops 48A and 48B/C as shown in FIG. 22N. Finally, the user presses back cover section 18B down on stack 60 so that the exposed adhesive will secure the front cover section to the stack in the region of the stack 60 near the spine as shown in FIG. 220.

In order to ensure that the lower portion of leaf section 88B is completely attached to the leaf section 60A near the spine, the user presses down on the leaf section 88B over the region where the underlying adhesive strip 96 is located as shown in FIG. 22P. Thus, the bound stack 60 will be secured to the front cover section 18A of the hardcover assembly by the leaf section 88B, with part of the leaf section also functioning to mask the underlying stitching 62. Similarly, as shown in FIG. 22Q, the user presses down on leaf section 90B over the region where the underlying adhesive strip 98 is located to further ensure that the back cover section 18B of the hardcover assembly is secured to the bound stack 60 by way of leaf section 90B. This completes the assembly process.

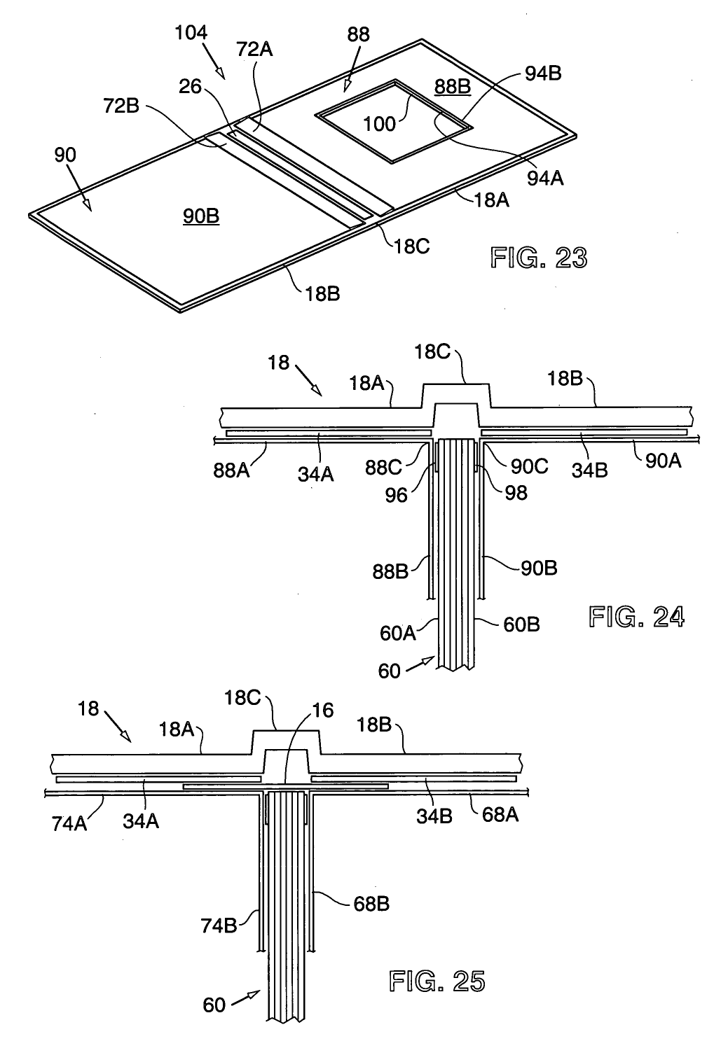

FIG. 24 is a schematic representation of the completed hardcover book. As can be seen, bound stack 60 is secured to the hardcover assembly 18 exclusively by the two pressure sensitive strips 96 and 98 and the portions of the end leaf sections near the folds of the sections, such as end leaf sections 88A and 88B near fold 88C. These regions are the most vulnerable portion of the alternative hardcover book and can be torn if the book is subjected to hard use. This can be compared to the earlier described embodiment as shown in FIG. 16 and FIG. 25 that uses an adhesive binder strip 16 thereby providing an inherently stronger bind. As a result of the use of a binder strip, the spine of the stack 60 is secured to the relatively heavy strip substrate 16 by the thermal adhesive (not depicted), with the substrate being secured to the hardcover assembly 18 by adhesives 34A and 34B over a substantial area. In this case, the pressure sensitive adhesive strips 70 and 76 (not depicted in FIG. 25) function primarily to secure a portion of respective leaf sections 74B and 68B to the outer sheets of stack 60 thereby masking any stitching.

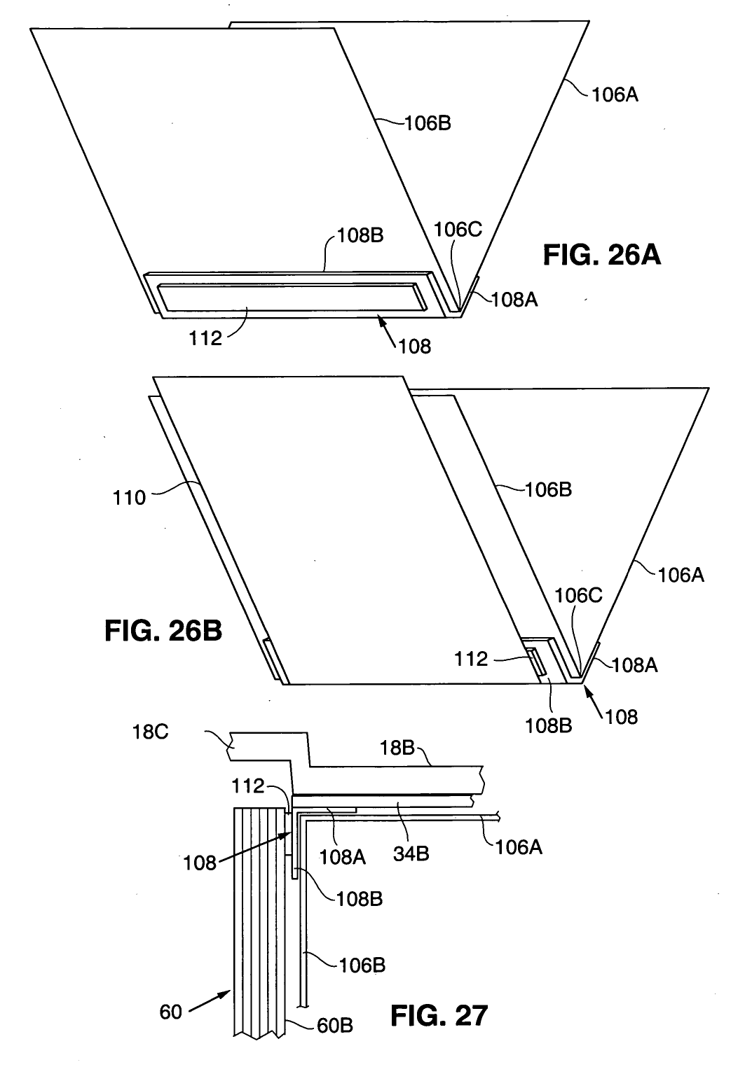

FIGS. 26A and 26B show an alternative end leaf assembly 106 which significantly enhances the strength of the hardcover book when a binding machine is not available for applying a binder strip 16. Assembly 106 is similar in construction to end leaf assembly 64 and includes leaf sections 106A and 106B formed by folding a single sheet along fold line 106C. A reinforcing member 108 is disposed along the fold line 106C and includes a reinforcing section 108B which extends up and is secured to leaf section 106B and a reinforcing section 108A which extends up and is secured to leaf section 106A. Reinforcing member 108 is fabricated from a flexible material having significant resistance to tearing such as the woven fabric mesh commonly used in bookbinding and bookbinding repair. By way of example, cotton or rayon mesh, fiber-reinforced paper or cambric tape may be used. Preferably, the end leaf assembly 106 is prefabricated with the reinforcing member 108 attached using a strong adhesive. End leaf assembly 106 is installed in the same manner previously described in connection with the other embodiment assemblies. FIG. 27 is a schematic representation of a portion of a hardcover book made using assembly 106. As can be seen, reinforcing section 108A extends along leaf section 106A a sufficient distance to ensure that a substantial portion of the section contacts adhesive 34B adhesive 34B of the back cover section 18B. Similarly, reinforcing section 108B extends along leaf section 106B a sufficient distance to ensure that section 108B contacts at least the full width of the pressure sensitive adhesive strip 112. Thus, it can be seen that the reinforcing member 108 significantly enhances the strength of the final hardcover book. The reinforcing member 108 can be added to the other embodiments of end leaf assemblies previously described, particularly in the event a binding machine is not available for applying a binder strip 16.

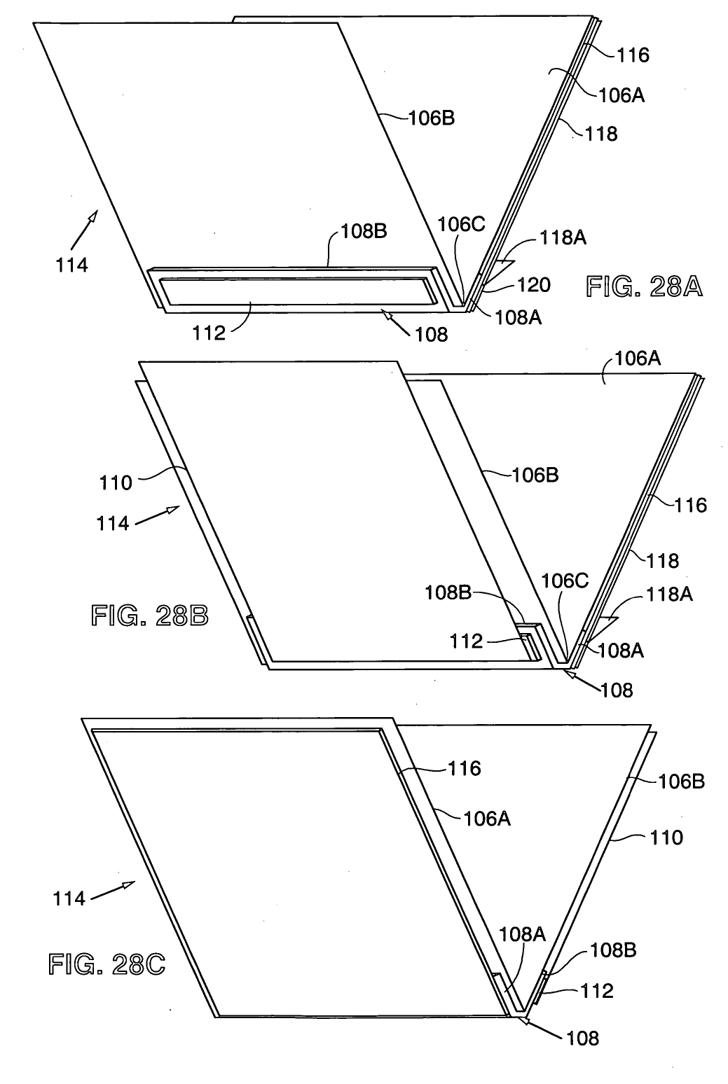

FIGS. 28A-28D depict a still further embodiment end leaf assembly 114 which is preferably manufactured and sold to a user as a separate item. As will be explained, the user then can directly apply a pair of the end leaf assemblies 114 to a bound stack 15 (FIG. 1) and then cover the resultant combination with a modified hardcover assembly 18. Alternatively, the user can affix a pair of the end leaf assemblies directly to a modified hardcover assembly 18 and then use the resultant combination to encase a bound stack 15.

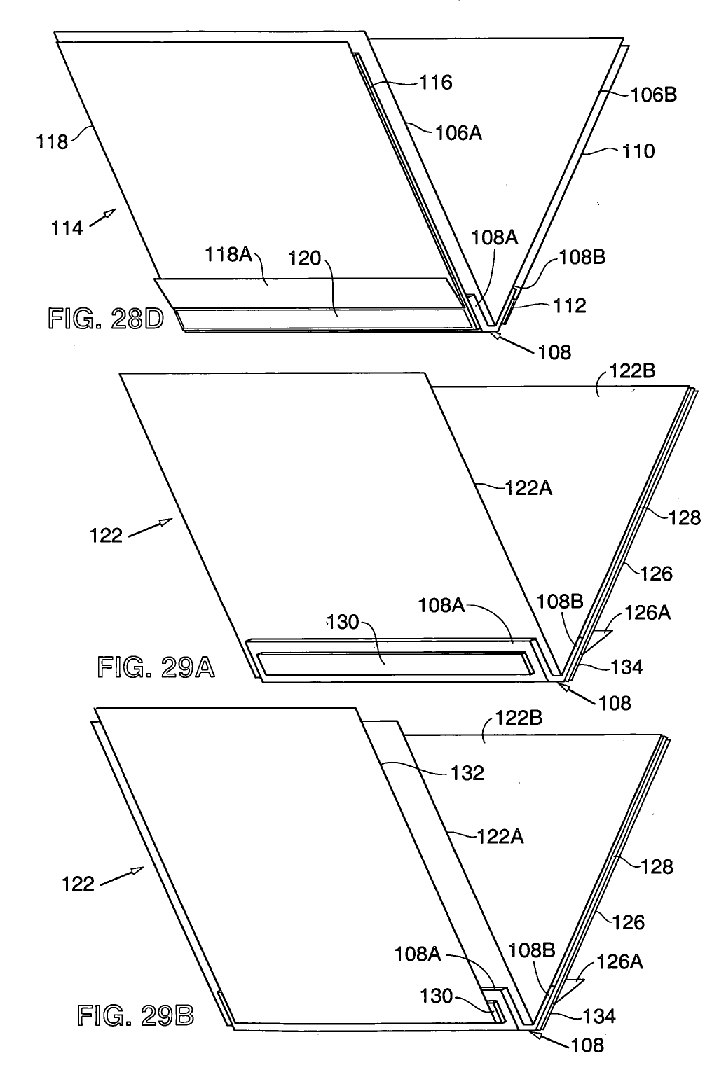

End leaf assembly 114 includes leaf sections 106A and 106B which, as previously described, are preferably formed from a single folded sheet. A reinforcing member 108, having reinforcing sections 108A and 108B is further provided, as previously described in connection with FIGS. 26A and 26B, to provide additional strength, if desired. A pressure sensitive adhesive strip 112 is disposed over reinforcing section 108B as also previously described. The adhesive strip 112 is covered with a release section or liner 110. As can best be seen in FIGS. 28C and 28D, a layer of pressure sensitive adhesive 116 is disposed over the outer surface of leaf section 106A and over reinforcing section 108A. A relatively narrow strip of adhesive layer 116 is covered by a minor release liner 120 (FIG. 28D), with the remainder of the layer 116 being covered by a major release liner 118. Major release liner 118 is provided with the folded tab 118A to facilitate removal of the liner 118 as will be described. FIGS. 29A and 29B depict a second end leaf assembly 122, similar in construction to end leaf assembly 114, to be used on combination with assembly 114.

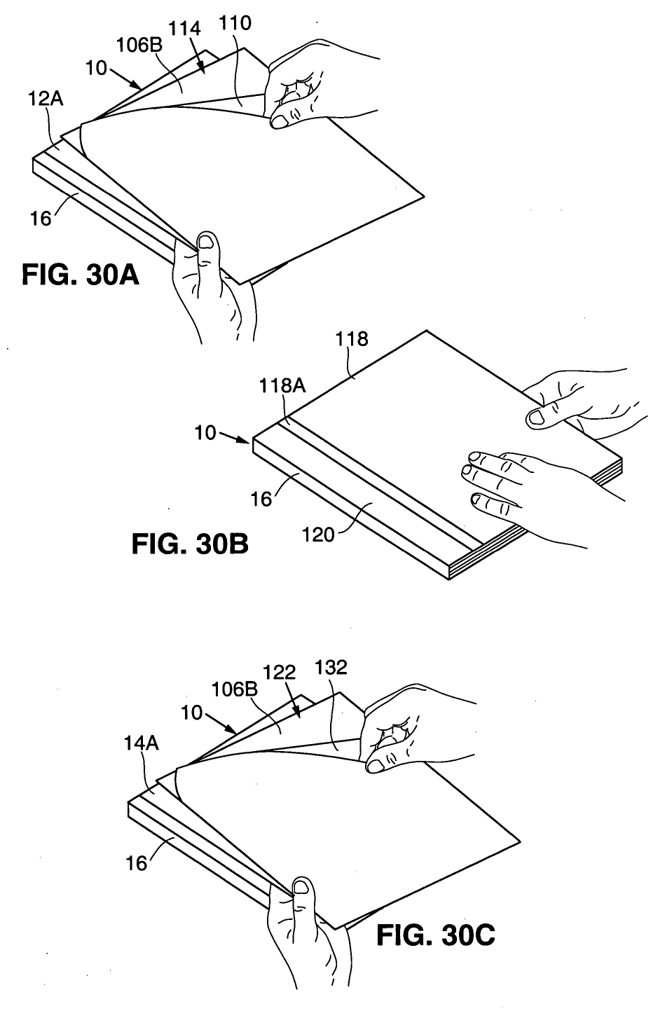

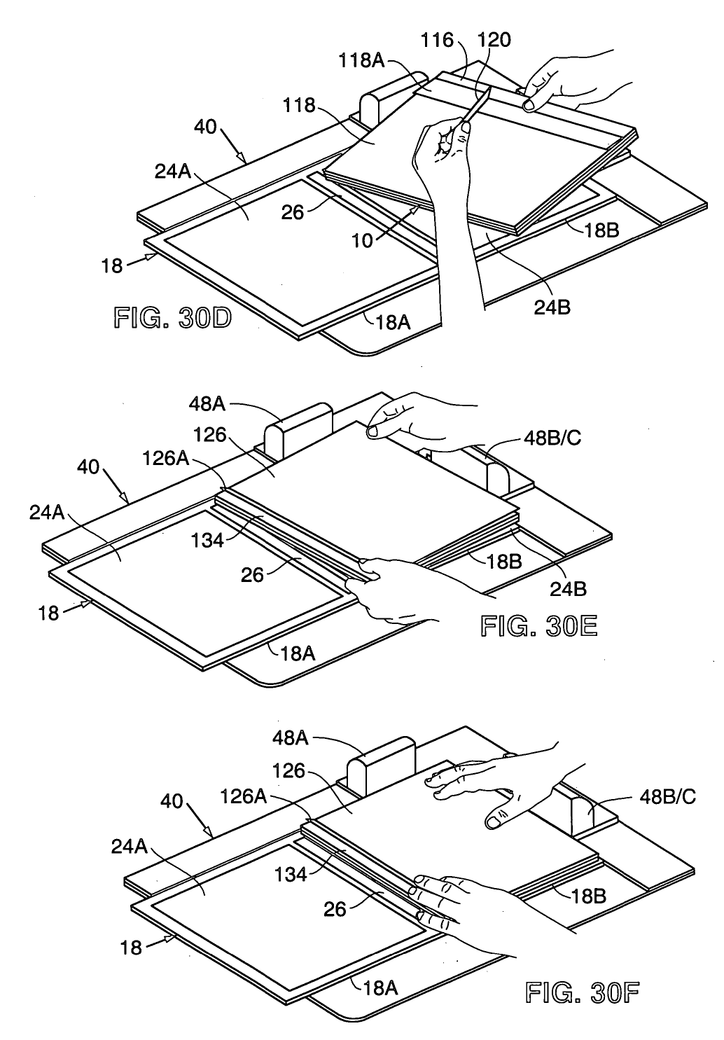

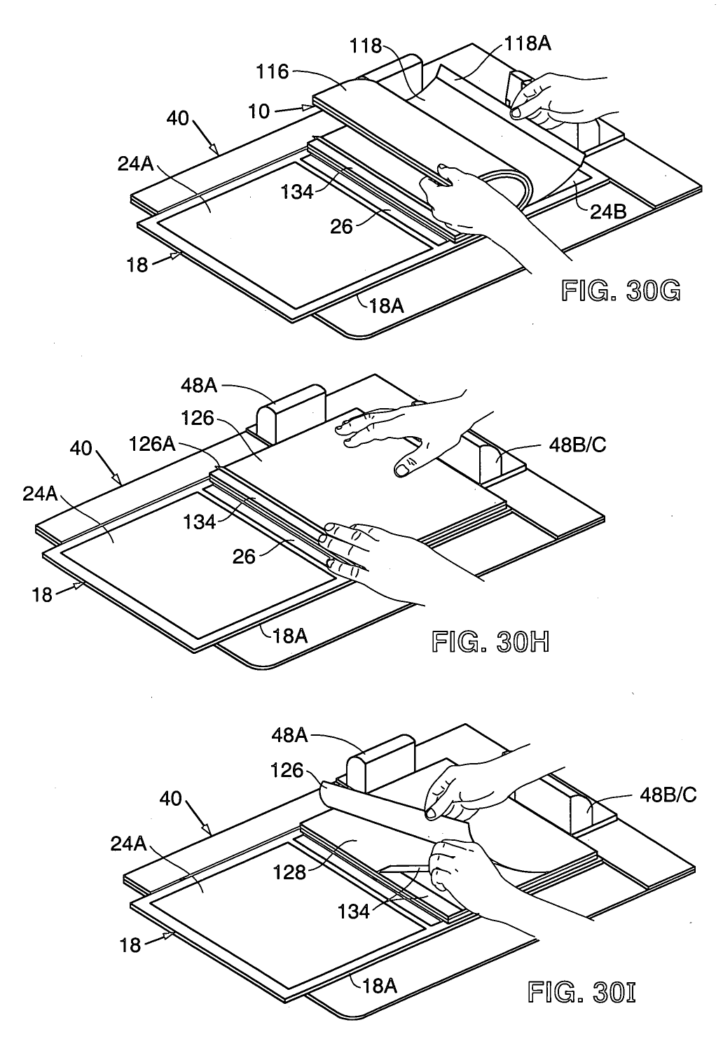

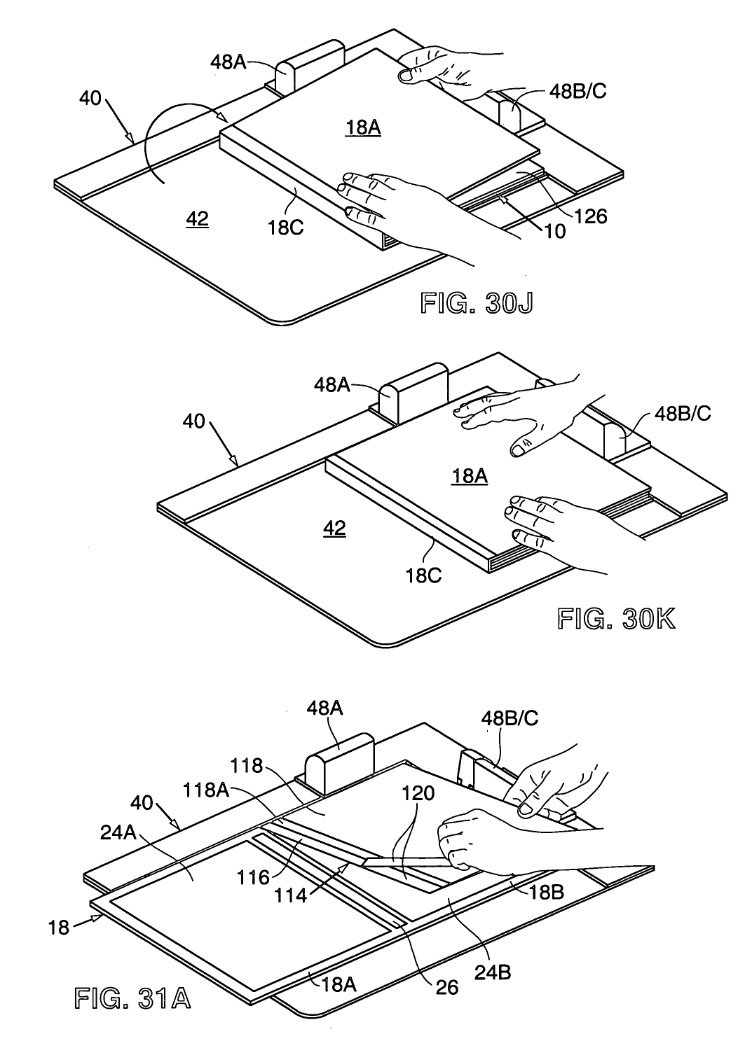

Two exemplary methods of using assemblies 114 and 122 for encasing a bound stack in a hardcover will now be described. A first step of the first method is shown in FIG. 30A. A previously bound stack 10 is shown, bound by way of a binder strip 16. Other methods of binding can also be used such as stitching and the like. The user first grips end leaf assembly 114 and removes release section 110 thereby exposing most of leaf section 106B and the pressure sensitive adhesive strip 112 (not shown in FIG. 30A). As shown in FIG. 30B, the user then carefully places the end leaf assembly 114 over sheet 12A of the bound stack, with the free edges of leaf sections 106A and 106B aligned with the free edges of sheet 12A and the other sheets of the stack. This initial placement is done without permitting the exposed adhesive strip 112 to contact sheet 12A of the stack 10. Once the initial placement has be completed, the user presses the end leaf 114 down in the stack 10 thereby securing a narrow portion of end sheet 106B and reinforcing section 108B to the stack 10, near the stack spine.

The second cover leaf assembly 122 is attached to sheet 12B of stack 10 in the same manner. As shown in FIG. 30C, the user first removes release section 132 thereby exposing pressure adhesive strip 130. The user then positions assembly 122 over the opposite side of the bound stack, with the free ends of end leafs 106A and 106B being aligned with the free ends of the sheets of stack 10. Again, care it taken not to contact sheet 14A of the stack 10 with adhesive strip 130 until alignment has been completed. Next, the user presses the end leaf assembly 122 down on the stack 10 in the region of adhesive strip 130 thereby securing the assembly 122 to the stack along the spine region. At this point, assembly 114 is secured to the front of stack 10 and assembly 122 is secured to the back of the stack.

The next step of the sequence is to apply a hardcover assembly to the stack 10/end leaf assembly combination. As shown in FIG. 30D, a hardcover assembly 18 is used which is similar to prior art assembly 18 of FIG. 3, but without the front and read adhesive assemblies 30A and 30B. Hardcover assembly 18 is first placed on the previously described hardcover guide apparatus 40, with the edges of back cover section 18B abutting the edge 44A of the guide apparatus as shown in FIG. 7. The user then removes minor release liner 120 of end leaf assembly 114 thereby exposing a narrow strip of the underlying pressure sensitive adhesive layer 116. Next, as shown in FIG. 30E, the user positions the stack 10/end leaf combination over the back cover section 18B of the hardcover assembly, with exposed adhesive 116 facing back cover board 24B. Vertical stops 48A and 48B/C are used to guide the placement, with care being taken not to permit the exposed adhesive 116 adjacent the spine from contacting the cover board 24B. After proper alignment, the user forces the stack/end leaf combination down on the hardcover assembly 18 as shown in FIG. 30F thereby securing the stack/end leaf combination with respect to the back cover section 18B hardcover assembly.

As shown in FIG. 30G, the user then lifts the free edge of the stack/end leaf combination, while not disturbing the fixed edge, thereby exposing the major release liner 118. The user then grips fold tab 118A of the release liner and removes the liner thereby exposing the remainder of the pressure sensitive adhesive 116. The user then presses the stack/end leaf combination down, completely securing leaf section 106A and reinforcing section 108A to back cover board 24B of the hardcover assembly by adhesive 116 as indicated in FIG. 30H. The user then exposes pressure sensitive adhesive layer 128 by removing both major and minor release liners 126 and 134 as shown in FIG. 30I. Front cover section 18A is then lifted and rotated over stack 10, as shown in FIG. 30J, until the edges of the cover section contact vertical stops 48A and 48B/C and as shown in FIG. 7. Care is taken not to permit the cover section 18A to contact the exposed adhesive 128 until the cover section is properly aligned. Finally, the user presses the stack/end leaf combination down as shown in FIG. 30K thereby securing leaf section 122B and reinforcing section 108B to the front cover board 24A of the hardcover assembly 18 thereby completing the process.

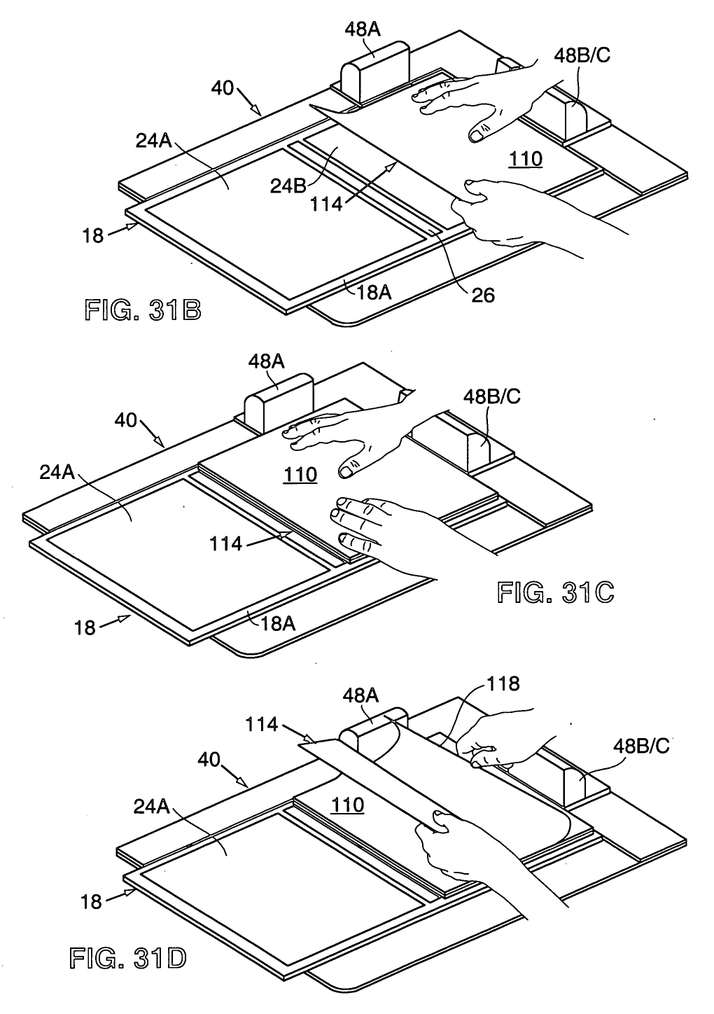

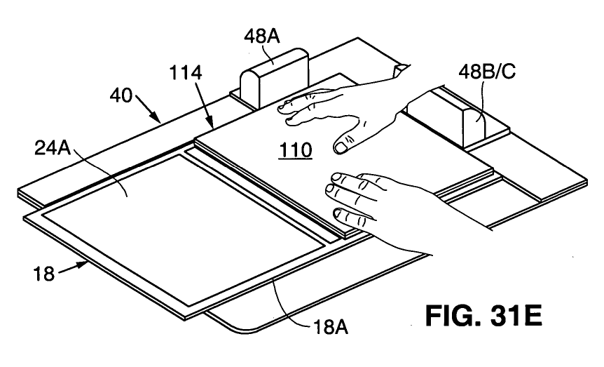

Alternatively, a user can first affix the end leaf assemblies 122 and 114 to the respective front and back cover boards 24A and 24B of the hardcover assembly 18. As shown in FIG. 31A, the user first positions the hardcover assembly 18 on the guide apparatus 40 substantially as previously described. Minor release liner 120 is then removed from end leaf assembly 114 thereby exposing a strip of adhesive layer 116. The user then positions end leaf assembly 114 over back cover board 24B, using stops 48A and 48B/C to accurately align the assembly 114, so that the exposed adhesive 116 is adjacent the spine region 26 of the hardcover assembly 18 as shown in FIG. 31B. Again, until the desired alignment is achieved, care is taken not to permit adhesive 116 from contacting back cover board 24B. The user then presses the assembly 114 down onto the cover board 24B thereby securing the alignment of the assembly 114 with respect to the cover board as shown in FIG. 31C. As shown in FIG. 31D, the user then lifts the free end of assembly 114 up so as to provide access to the major release liner 118. The major release liner 118 is removed thereby exposing the remainder of adhesive layer 116 and the end leaf assembly 114 is forced down against cover board 24B thereby securing the remainder of the reinforcing section 108A and leaf section 106A to the cover board.

The user then attaches the second end leaf assembly 122 to the hardcover assembly 18. The hardcover assembly is first repositioned on the hardcover guide apparatus so that front back cover section 18A is positioned in the same manner as back cover section 18B of FIG. 7. The user then repeats the previously described steps depicted in FIGS. 31A-31E, using end leaf assembly 122 rather than assembly 114. This completes the preparation of the hardcover assembly, with the hardcover assembly being substantially the same as the hardcover assembly of FIG. 23, but without the viewing window 100. The user then applies the completed hardcover assembly to a bound stack substantially in the same manner as previously described in connection with FIGS. 22A-22Q.

Thus, various embodiments of end leaf assemblies, hardcover assemblies and related methods have been disclosed. Although these embodiments have been described in some detail, it should be noted that persons skilled in the relevant art can make changes without departing from the spirit and scope of the present invention as defined by the appended claims.

What is claimed is:

1. An end leaf assembly for use in securing a hardcover assembly to a stack of sheets, said end leaf assembly comprising:
a first leaf section substantially a same length and width as the sheets of the stack of sheets;
a second leaf section having a same length as the first leaf section, with said second leaf section being coupled to said first leaf section to form a first edge along the length of the first and second leaf sections;
a strip of pressure sensitive adhesive disposed on the second leaf section and extending along the first edge substantially a full length of the second leaf section and displaced from the first edge at least 1/16 of an inch, with said strip having a width in a direction normal to the first edge no greater than 2.0 inches; and
a release liner disposed over the strip of pressure sensitive adhesive.

2. The end leaf assembly of claim 1 wherein said first and second leaf sections are formed from a single sheet, with the sheet being folded to form the first edge.

3. The end leaf assembly of claim 2 wherein the first and second leaf sections have a generally same width.

4. The end leaf assembly of claim 2 wherein the second leaf section has a width substantially smaller than the width of the first leaf section.

5. The end leaf assembly of claim 2 wherein the release liner has a width such that the release liner extends past a second edge, opposite the first edge, of the second leaf section.

6. The end leaf assembly of claim 1 further including a layer of pressure sensitive adhesive disposed over a surface of the first leaf section and a second release liner disposed over the layer of pressure sensitive adhesive.

7. The end leaf assembly of claim 6 wherein the first and second leaf sections are formed from a single sheet, with the single sheet being folded to form the first edge and wherein the strip of pressure sensitive adhesive and the layer of pressure sensitive adhesive are disposed on a same side of the single sheet.

8. The end leaf assembly of claim 7 further including a reinforcing member folded around the first edge, with a first section being secured to the first leaf section and a second section of the reinforcing member being secured to the second section.

9. The end leaf assembly of claim 8 wherein at least a portion of the first section of the reinforcing member is disposed intermediate the layer of pressure sensitive adhesive and the first leaf section.

10. The end leaf assembly of claim 9 wherein at least a portion of the second section of the reinforcing member is disposed intermediate second leaf section and the strip of pressure sensitive adhesive.

11. An end leaf assembly for use in securing a hardcover assembly to a stack of sheets, said end leaf assembly comprising:
a first leaf section substantially a same length and width as the sheets of the stack of sheets;
a second leaf section having a same length as the first leaf section, with said second leaf section being coupled to said first leaf section to form a first edge along the length of the first and second leaf sections;
a reinforcing member folded around the first edge, with a first section of the reinforcing member being secured to the first leaf section and a second section of the reinforcing member being secured to the second leaf section
a strip of pressure sensitive adhesive disposed on the second section of the reinforcing member and extending along the first edge substantially a full length of the second leaf section, with said strip having a width in a direction normal to the first edge no greater than 2.0 inches; and
a release liner disposed over the strip of pressure sensitive adhesive.

12. The end leaf assembly of claim 11 further including a layer of pressure sensitive adhesive disposed on the first end leaf section and a second release liner disposed over the layer of pressure sensitive adhesive, with at least a portion of a first section of the reinforcing member being disposed intermediate the layer of pressure sensitive adhesive and the first leaf section and with at least a portion of a second section of the reinforcing member being disposed intermediate the second end leaf section and the strip of pressure sensitive adhesive.

13. The end leaf assembly of claim 11 wherein the reinforcing member includes a mesh layer.

14. A hardcover assembly comprising:
a relatively rigid first cover section;
a relatively rigid second cover section;
a relatively flexible spine section intermediate and connected to the first and second cover sections;
a first end leaf assembly including
(a) a first leaf section disposed on an interior surface of the first cover section,
(b) a second leaf section coupled to the first leaf section to form a first edge disposed along a length of a first junction between the first cover section and the spine section,
(c) a first strip of pressure sensitive adhesive disposed on a surface of the second leaf section facing the spine section, and
(d) a first release liner disposed over the first strip of pressure sensitive adhesive; and
a second end leaf assembly including
(a) a third leaf section disposed on an interior surface of the second cover section,
(b) a fourth leaf section coupled to the second leaf section to form a second edge disposed along a length of a second junction between the second cover section and the spine section,
(c) a second strip of pressure sensitive adhesive disposed on a surface of the fourth leaf section facing the spine section and
(d) a second release liner disposed over the second strip of pressure sensitive adhesive.

15. The hardcover assembly of claim 14 wherein said first and second leaf sections are formed from a single sheet folded along said first edge and wherein said third and fourth leaf sections are formed from a single sheet folded along said second edge.

16. The hardcover assembly of claim 14 wherein said first and second strips of pressure sensitive adhesive extend less than 2.0 inches from the respective first and second edges.

17. The hardcover assembly of claim 14 wherein said first end leaf assembly further includes a first reinforcing member folded around the first edge and a second reinforcing member folded around the second edge, with the first reinforcing member including a first section disposed intermediate the first leaf section and the first cover section and a second section disposed intermediate the second leaf section and the first strip of pressure sensitive adhesive and with the second reinforcing member including a first section disposed intermediate the third leaf section and the second cover section and a second section disposed intermediate the third leaf section and the second strip of pressure sensitive adhesive.

18. The hardcover assembly of claim 12 wherein the first and second reinforcing members each include a mesh layer.

19. A method of applying a bound stack of sheets to a hardcover assembly to create a hardcover book, with the hardcover assembly including relatively rigid first and second cover sections connected by an intermediate spine section, said method comprising:
providing first and second end leaf assemblies, with each of the end leaf assemblies including
(a) a first leaf section,
(b) a second leaf section coupled to the first leaf section to form a first edge,
(c) a strip of pressure sensitive adhesive disposed on said second leaf section and extending along the first edge,
(d) a release liner disposed over the strip of pressure sensitive adhesive;
securing the first leaf section of the first end leaf assembly to an interior surface of said first cover section;
securing the first leaf section of the second end leaf assembly to an interior surface of said second cover section;
positioning the stack of sheets so that a stack edge is positioned near the spine section;
removing the release liner of the first end leaf assembly so as to expose the strip of pressure sensitive adhesive;
securing the second leaf section of the second end leaf assembly to a first outer sheet of the stack by way of the exposed pressure sensitive adhesive of the first end leaf assembly;
removing the release liner of the second end leaf assembly so as to expose the strip of pressure sensitive adhesive; and
securing the second leaf section of the second end leaf assembly to a second outer sheet of the stack by way of the exposed pressure sensitive adhesive of the second end leaf assembly.

20. The method of claim 19 wherein the bound stack has been bound using stitching and wherein the securing the second leaf section of the first end leaf assembly includes covering the stitching at the first outer sheet with the exposed pressure sensitive adhesive of the first end leaf assembly and wherein the securing the second leaf section of the second end leaf assembly includes covering the stitching at the second outer sheet with the exposed pressure sensitive adhesive of the second end leaf assembly.

21. The method of claim 19 wherein the bound stack has been bound using stitching and wherein the securing the second leaf section of the first end leaf assembly includes covering less than 10 percent of the first outer sheet with the exposed pressure sensitive adhesive of the first end leaf assembly and wherein the securing the second leaf section of the second end leaf assembly includes covering less than 10 percent of the second outer sheet with the exposed pressure sensitive adhesive of the second end leaf assembly.

22. The method of claim 19 wherein prior to the positioning of the stack of sheets, binding the first and second end leaf assemblies to the stack of sheets.

23. The method of claim 22 wherein the binding is carried out using a thermal activated adhesive binder strip.

24. The method of claim 23 wherein the securing of first leaf section of the first end leaf assembly to the interior surface of the first cover section includes positioning a portion of a substrate of the adhesive binder strip between the first leaf section and the first cover section and wherein the securing of the first leaf section of the second end leaf assembly to the interior surface of the second cover section includes positioning a portion of the substrate of the adhesive binder strip between the first leaf section and the second cover section.

25. A method of applying a bound stack of sheets to a hardcover assembly to create a hardcover book, with the hardcover assembly including relatively rigid first and second cover sections connected by an intermediate spine section, said method comprising:
providing first and second end leaf assemblies, with each of the end leaf assemblies including
(a) a first leaf section,
(b) a layer of pressure sensitive adhesive disposed over a surface of the first leaf section;
(c) a release liner assembly disposed over the layer of pressure sensitive adhesive;
(b) a second leaf section coupled to the first leaf section to form a first edge,
(c) a strip of pressure sensitive adhesive disposed on said second leaf section and extending along the first edge,
(d) a release liner disposed over the strip of pressure sensitive adhesive;
removing the release liner assembly of the first end leaf assembly;
securing the first leaf section of the first end leaf assembly to an interior surface of said first cover section using the layer of pressure sensitive adhesive of the first end leaf assembly;
removing the release liner assembly of the second end leaf assembly;
securing the first leaf section of the second end leaf assembly to an interior surface of said second cover section using the layer of pressure sensitive adhesive of the second end leaf assembly;
positioning the stack of sheets so that a stack edge is positioned near the spine section;
removing the release liner of the first end leaf assembly so as to expose the strip of pressure sensitive adhesive;
securing the second leaf section of the second end leaf assembly to a first outer sheet of the stack by way of the exposed strip of pressure sensitive adhesive of the first end leaf assembly;
removing the release liner of the second end leaf assembly so as to expose the strip of pressure sensitive adhesive; and
securing the second leaf section of the second end leaf assembly to a second outer sheet of the stack by way of the exposed pressure sensitive adhesive of the second end leaf assembly.

26. The method of claim 25 wherein release liner assembly of the first end leaf assembly includes first and second release liner sections and wherein the steps of removing the release liner assembly of the first end leaf assembly and the securing the first leaf section of the first end leaf assembly to an interior surface of the first cover section include
removing the first release liner section thereby exposing a first portion of the layer of pressure sensitive adhesive;
securing the first end leaf section to the interior surface of said first cover section using the first portion of the layer of pressure sensitive adhesive;
removing the second release liner section thereby exposing a second portion of the layer of pressure sensitive adhesive; and
securing the first end leaf section to the interior surface of said first cover section using the second portion of the layer of pressure sensitive adhesive.

27. The method of claim 26 wherein release liner assembly of the second end leaf assembly includes first and second release liner sections and wherein the steps of removing the release liner assembly of the second end leaf assembly and the securing the first leaf section of the second end leaf assembly to an interior surface of the second cover section include
removing the first release liner section thereby exposing a first portion of the layer of pressure sensitive adhesive;
securing the first end leaf section to the interior surface of said second cover section using the first portion of the layer of pressure sensitive adhesive;
removing the second release liner section thereby exposing a second portion of the layer of pressure sensitive adhesive; and
securing the first end leaf section to the interior surface of said second cover section using the second portion of the layer of pressure sensitive adhesive.

28. A method of applying a bound stack of sheets to a hardcover assembly to create a hardcover book, with the hardcover assembly including relatively rigid first and second cover sections connected by an intermediate spine section, said method comprising:
providing first and second end leaf assemblies, with each of the end leaf assemblies including
(a) a first leaf section,
(b) a layer of pressure sensitive adhesive disposed over a surface of the first leaf section;
(c) a release liner assembly disposed over the layer of pressure sensitive adhesive;
(b) a second leaf section coupled to the first leaf section to form a first edge,
(c) a strip of pressure sensitive adhesive disposed on said second leaf section and extending along the first edge,
(d) a release liner disposed over the strip of pressure sensitive adhesive;
removing the release liner of the first end leaf assembly;
securing the second leaf section of the first end leaf assembly to a first outer sheet of the stack using the strip of pressure sensitive adhesive of the first end leaf assembly;
removing the release liner of the second end leaf assembly;
securing the second leaf section of the second end leaf assembly to a second outer sheet of the stack using the strip of pressure sensitive adhesive of the second end leaf assembly;
removing the release liner assembly of the first end leaf assembly so as to expose the layer of pressure sensitive adhesive;
securing the first leaf section of the first end leaf assembly to an interior surface of the first cover section by way of the exposed layer of pressure sensitive adhesive of the first end leaf assembly;
removing the release liner assembly of the second end leaf assembly so as to expose the layer of pressure sensitive adhesive; and
securing the first leaf section of the second end leaf assembly to an interior surface of the second cover section by way of the exposed layer of pressure sensitive adhesive of the second end leaf assembly.

29. The method of claim 28 wherein release liner assembly of the first end leaf assembly includes first and second release liner sections and wherein the steps of removing the release liner assembly of the first end leaf assembly and the securing the first leaf section of the first end leaf assembly to an interior surface of the first cover section include
removing the first release liner section thereby exposing a first portion of the layer of pressure sensitive adhesive;
securing the first end leaf section to the interior surface of said first cover section using the first portion of the layer of pressure sensitive adhesive;
removing the second release liner section thereby exposing a second portion of the layer of pressure sensitive adhesive; and
securing the first end leaf section to the interior surface of said first cover section using the second portion of the layer of pressure sensitive adhesive.

30. The method of claim 29 wherein release liner assembly of the second end leaf assembly includes first and second release liner sections and wherein the steps of removing the release liner assembly of the second end leaf assembly and the securing the first leaf section of the second end leaf assembly to an interior surface of the second cover section include
removing the first release liner section thereby exposing a first portion of the layer of pressure sensitive adhesive;
securing the first end leaf section to the interior surface of said second cover section using the first portion of the layer of pressure sensitive adhesive;
removing the second release liner section thereby exposing a second portion of the layer of pressure sensitive adhesive; and
securing the first end leaf section to the interior surface of said second cover section using the second portion of the layer of pressure sensitive adhesive.

31. An end leaf assembly for use in securing a hardcover assembly to a stack of sheets, said end leaf assembly comprising:
a first leaf section substantially a same length and width as the sheets of the stack of sheets;
a second leaf section having a same length as the first leaf section, with said second leaf section being coupled to said first leaf section to form a first edge along the length of the first and second leaf sections;
a strip of pressure sensitive adhesive disposed on the second leaf section and extending along the first edge substantially a full length of the second leaf section for securing the end leaf assembly to an outer sheet of the stack, with said strip having a width in a direction normal to the first edge no greater than 2.0 inches;
a release liner disposed over the strip of pressure sensitive adhesive;
a layer of pressure sensitive adhesive disposed over the first leaf for securing the first leaf section to an inner surface of cover of the hardcover assembly; and
a release liner assembly disposed over the layer of pressure sensitive adhesive.

32. The end leaf assembly of claim 31 wherein said first and second leaf sections are formed from a single sheet, with the sheet being folded to form the first edge.

33. The end leaf assembly of claim 32 wherein the first and second leaf sections have a generally same width.

34. The end leaf assembly of claim 32 wherein the second leaf section has a width substantially smaller than the width of the first leaf section.

35. The end leaf assembly of claim 32 wherein the release liner has a width such that the release liner extends past a second edge, opposite the first edge, of the second leaf section.

36. The end leaf assembly of claim 31 wherein the release liner assembly includes first and second release liner sections disposed over respective first and second portions of the layer of pressure sensitive adhesive.

37. The end leaf assembly of claim 31 wherein the first and second leaf sections are formed from a single sheet, with the single sheet being folded to form the first edge and wherein the strip of pressure sensitive adhesive and the layer of pressure sensitive adhesive are disposed on a same side of the single sheet.

38. The end leaf assembly of claim 31 further including a reinforcing member folded around the first edge, with a first section being secured to the first leaf section and a second section of the reinforcing member being secured to the second section.

39. The end leaf assembly of claim 38 wherein at least a portion of the first section of the reinforcing member is disposed intermediate the layer of pressure sensitive adhesive and the first leaf section.

40. The end leaf assembly of claim 39 wherein at least a portion of the second section of the reinforcing member is disposed intermediate second leaf section and the strip of pressure sensitive adhesive.
